(19) United States
(12) Patent Application Publication
(10) Pub. No.: US 2015/0022784 A1
(43) Pub. Date: Jan. 22, 2015

(54) OPTICAL ELEMENT, OPTICAL DEVICE, AND DISPLAY DEVICE

(71) Applicant: NEC CORPORATION, Tokyo (JP)

(72) Inventors: Shin Tominaga, Tokyo (JP); Masao Imai, Tokyo (JP); Masanao Natsumeda, Tokyo (JP)

(73) Assignee: NEC CORPORATION, Tokyo (JP)

(21) Appl. No.: 14/382,817

(22) PCT Filed: Mar. 4, 2013
(86) PCT No.: PCT/JP2013/001291

§ 371 Date: Sep. 4, 2014

(30) Foreign Application Priority Data
Mar. 7, 2012 (JP) 2012-050647

(51) Int. Cl. G02B 5/30; H04N 9/31

(52) U.S. Cl. CPC G02B 5/3033; G02B 5/3083; H04N 9/3167
USPC 353/20; 359/489.01

(57) ABSTRACT

An optical element of the present invention has a first dielectric layer, a second dielectric layer and a first metal layer arranged between the first dielectric layer and the second dielectric layer, and is characterized that the first dielectric layer has different refractive indices in a first direction, and a second direction intersecting with the first direction.

### TECHNICAL FIELD

The present invention relates to an optical element, an optical device and a display device which convert randomly polarized light to a specifically polarization state.

### BACKGROUND ART

In recent years, an LED projector which uses an LED (Light Emitting Diode) as a light source is noted. An LED projector includes an LED, an illumination optical system which emitted light of the LED enters, a modulation element which modulates and emits light from the illumination optical system according to a video signal, and a projection optical system which projects light from the modulation element on a screen.

In the above-mentioned LED projector, in order to raise a luminance of a projection image, it is required to use emitted light of a light source as projection light efficiently. In order to utilize light from a light source efficiently as projection light, it is necessary for etendue determined by the product of the light emitting area and the angle of the divergence of the light source to be smaller than the product of the light reception area of the modulation element and the acceptance angle determined by the F-number of the illumination optical system.

In the above-mentioned LED projector, a modulation element having polarization dependency such as a liquid crystal panel may be used. In this case, because the emitted light of the LED is randomly polarized light, in order to use the light from the light source as projection light efficiently, the randomly polarized light needs to be converted to a specifically polarization state.

An art which converts randomly polarized light to a specifically polarization state is disclosed by Patent Document 1.

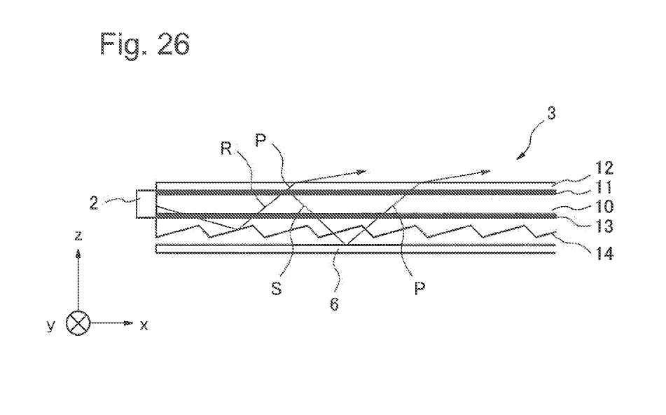

As shown in FIG. 26, a planar lighting system described in Patent Document 1 has a light guide plate 3 including a light guide 10, a polarization direction change member 13 provided on a lower surface of the light guide 10, a stair-like micro prism 14, a reflector 6, a polarization separation film 11 provided on an upper surface of the light guide 10 and an upper surface cover 12 provided on an upper surface of the polarization separation film 11. The polarization separation film 11 has a configuration in which a metal thin film is sandwiched with a first low refractive index transparent medium and second low refractive index transparent medium.

In the above-mentioned planar lighting system, an emitted light of an LED 2 enters the light guide 10, and propagates in the light guide 10 while an angle thereof is converted by a micro prism 14. When the incident light is totally reflected off a first boundary that is a boundary of the light guide 10 and a first low refractive index transparent medium, a surface plasmon is excited on the metal thin film by an evanescent wave generated then. When the surface plasmon is excited on the metal thin film, a transition process contrary to the excitation process of the surface plasmon generates at a second boundary that is a boundary of a second low refractive index transparent medium and the upper surface cover 12, and light is generated at the second boundary thereof. The light generated at the second boundary is emitted via the upper surface cover 12.

In the above-mentioned planar lighting system, a light which excites the surface plasmon in lights which enter the first boundary is only a P polarized light with an the electric field component parallel to the first boundary. Because the light which is generated at the second boundary is generated by a process contrary to the excitation process of the surface plasmon, it will be the same P polarized light as the light which excites the surface plasmon. Accordingly, the above-mentioned planar lighting system converts randomly polarized light to a specifically polarization state, and can emit it.

### PRIOR ART LITERATURE

### Patent Literature

[Patent literature 1] Japanese Patent Application Laid-Open No. 2003-295183

### SUMMARY OF INVENTION

### Problems to be Solved by the Invention

In the planar lighting system of Patent Document 1, lights which travel in the light guide 10 spread through not only a specified direction but also various directions and enter the first boundary surface from various directions. As a result, the surface plasmon spread through various directions in the plane of the metal thin film surface generates, and the lights which generate at the second boundary are also emitted in the various directions. Therefore, a problem that it was difficult to obtain a light whose emission direction was fixed in the specified direction in a specifically polarization state that was in a low state of the etendue occurred.

An object of the present invention is to provide an optical element, an optical device and a display device which can convert a randomly polarized light to a specifically polarization state that is in a low state of the etendue in which the emission direction thereof is fixed in a specified direction.

### Means for Solving the Problems

An optical element of the present invention has a first dielectric layer, a second dielectric layer and a first metal layer disposed between the first dielectric layer and the second dielectric layer, and the first dielectric layer has different refractive indices in a first direction and a second direction intersecting with the first direction.

### Advantageous Effects of Invention

According to the present invention, it becomes possible to convert randomly polarized light to a specifically polarization state that is in the low state of the etendue.

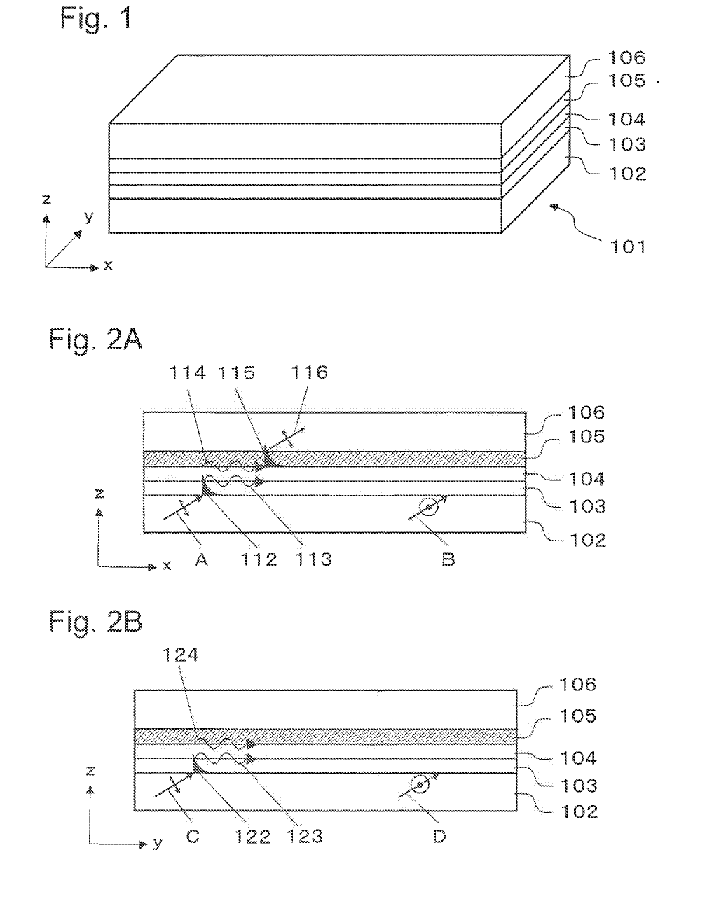

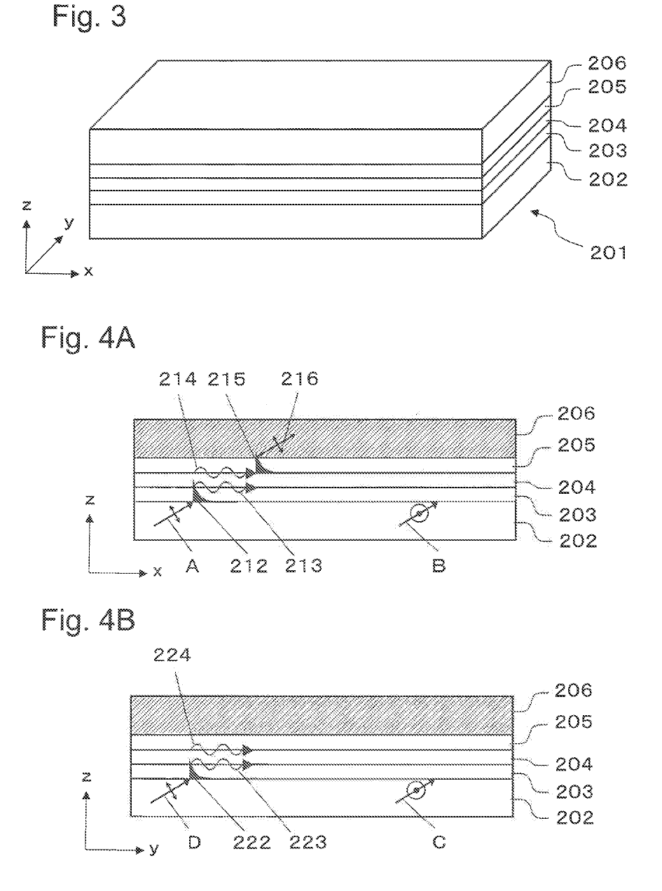

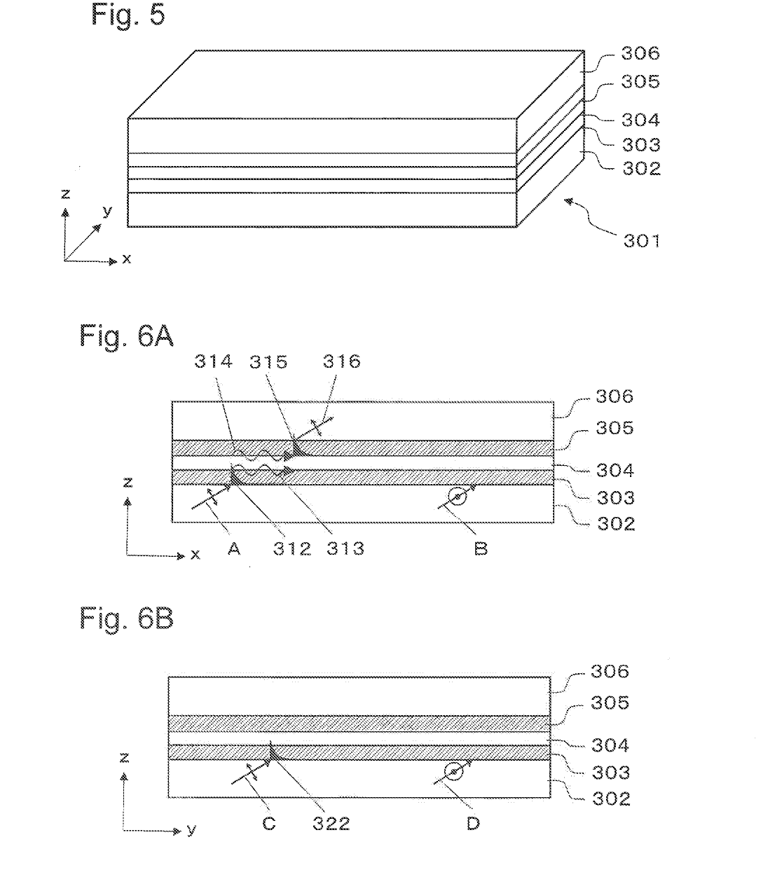

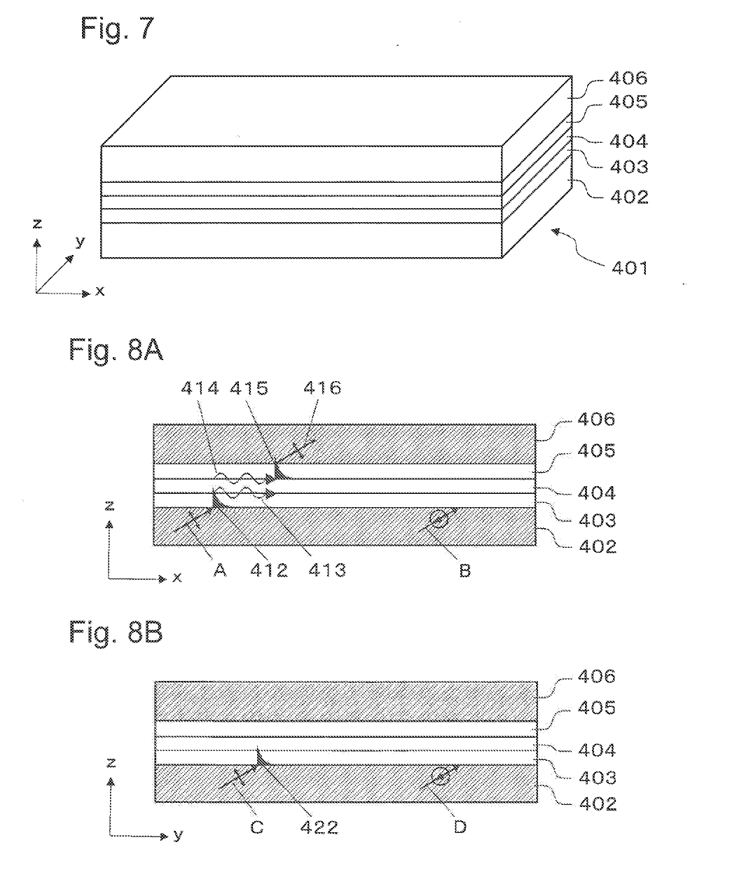

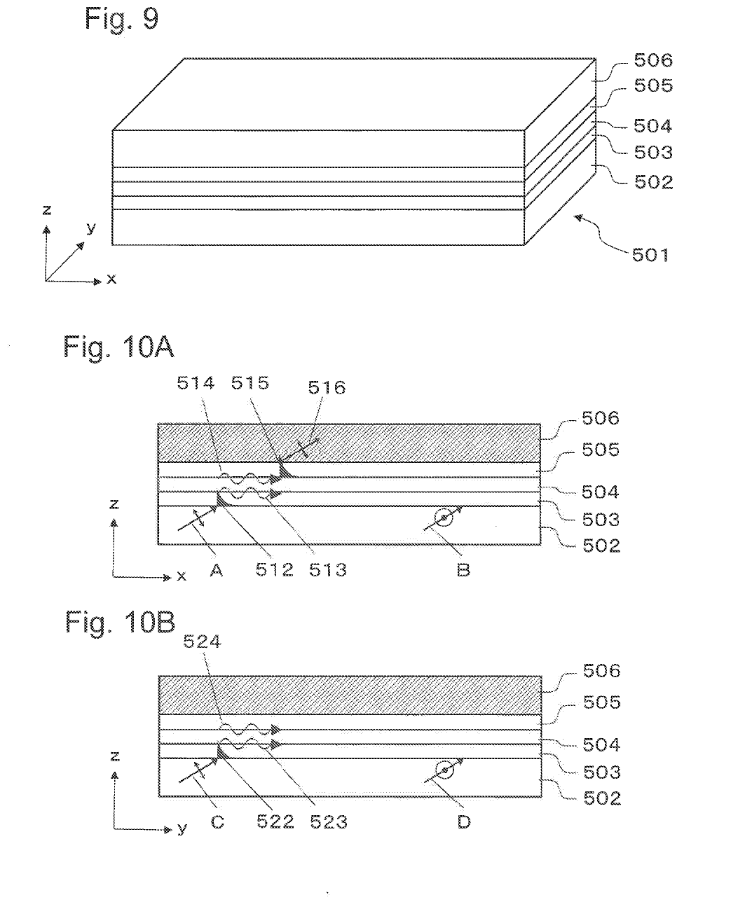

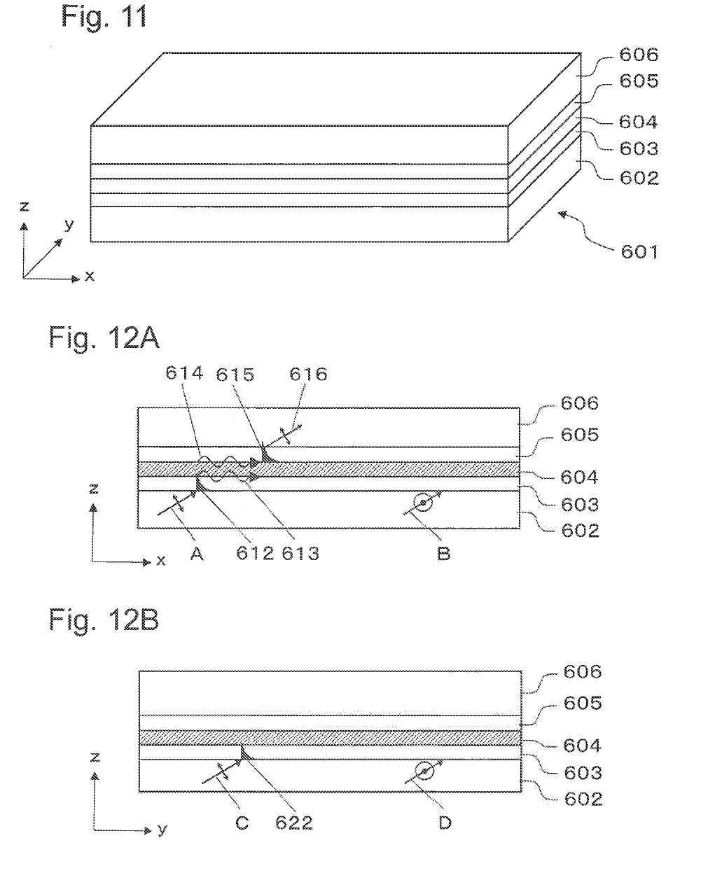

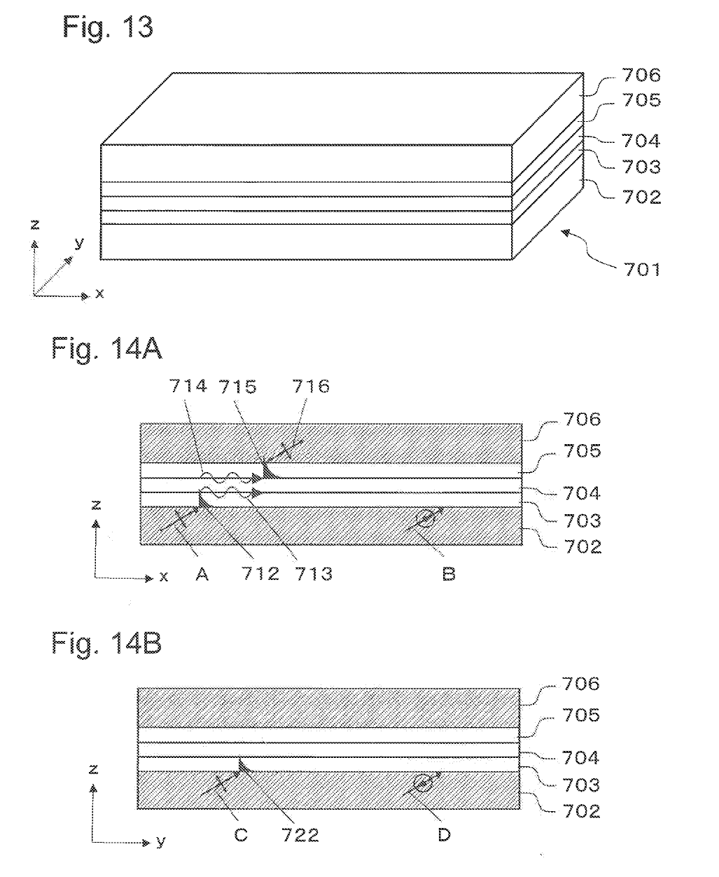

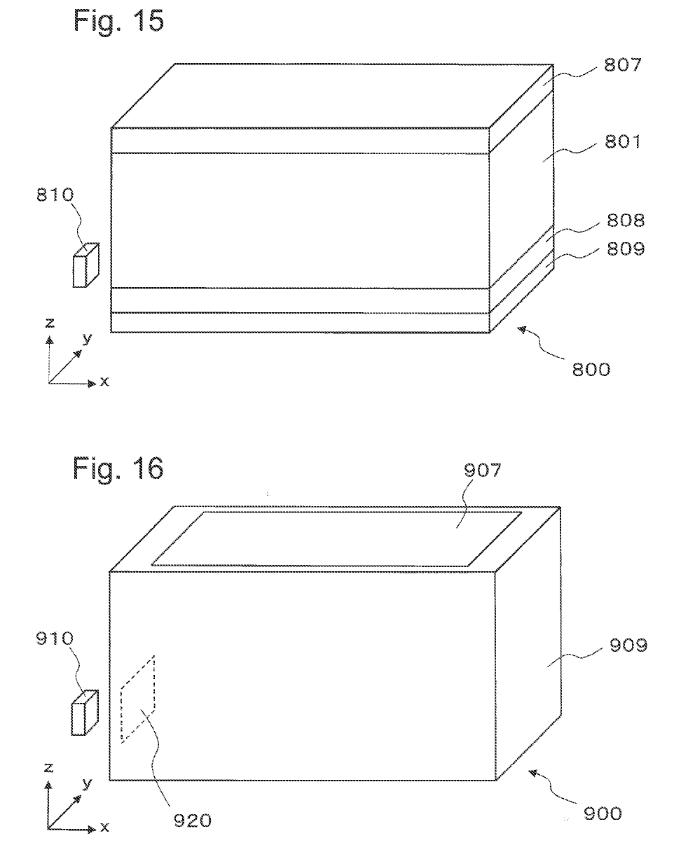

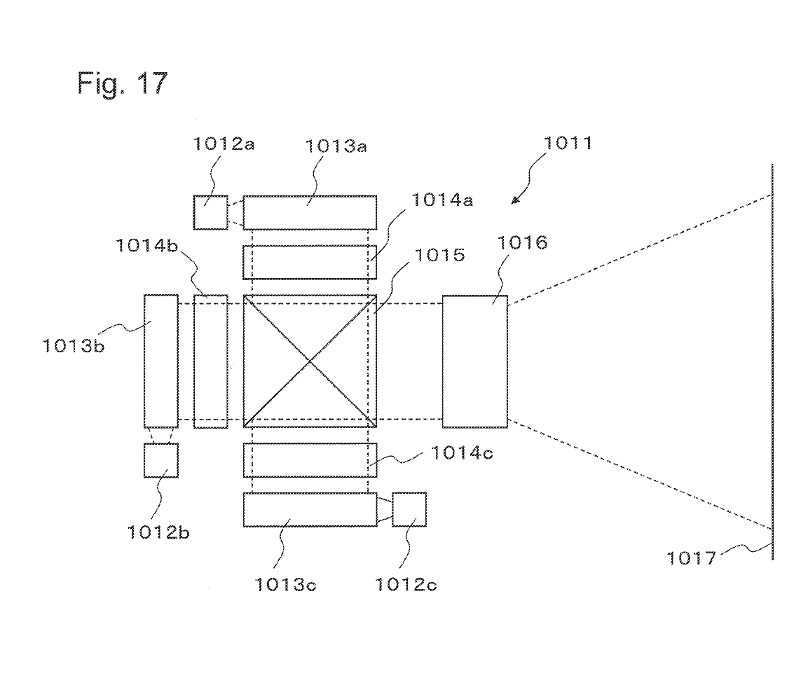

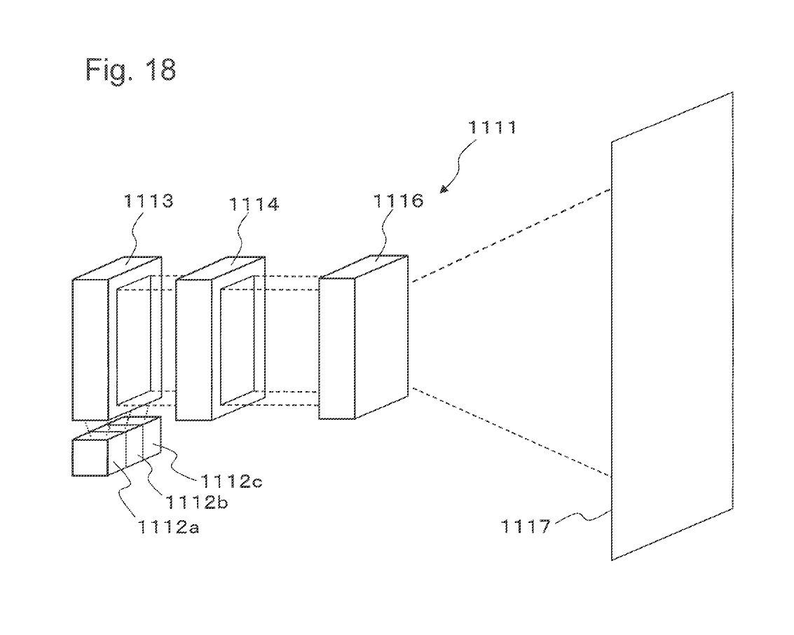

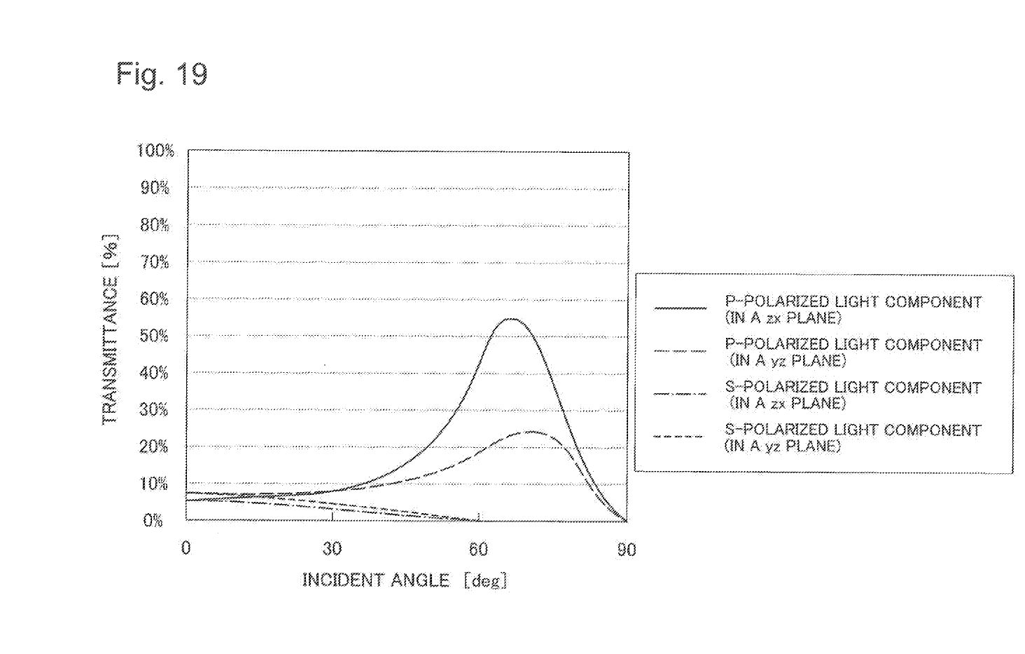

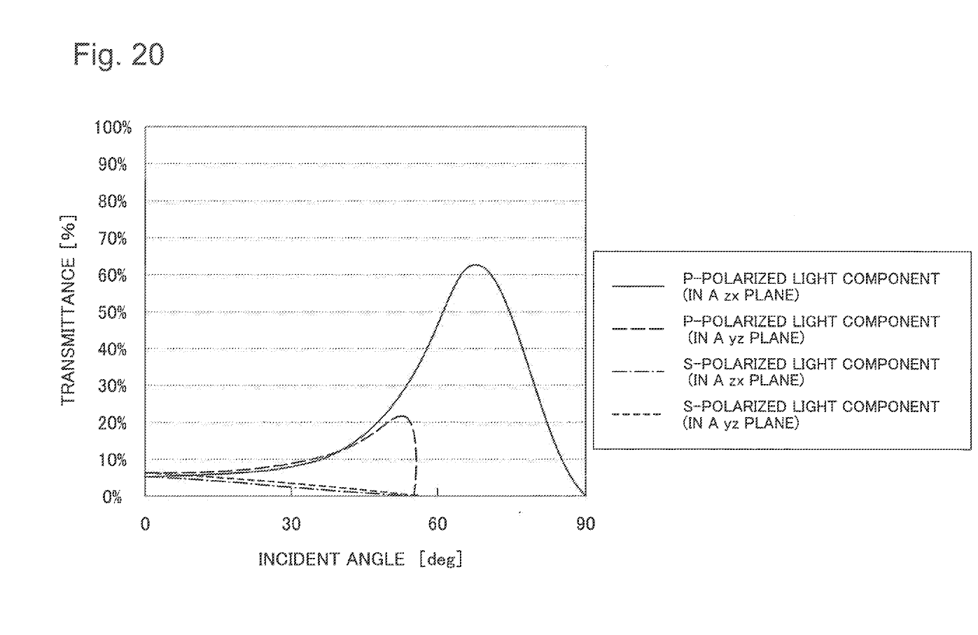

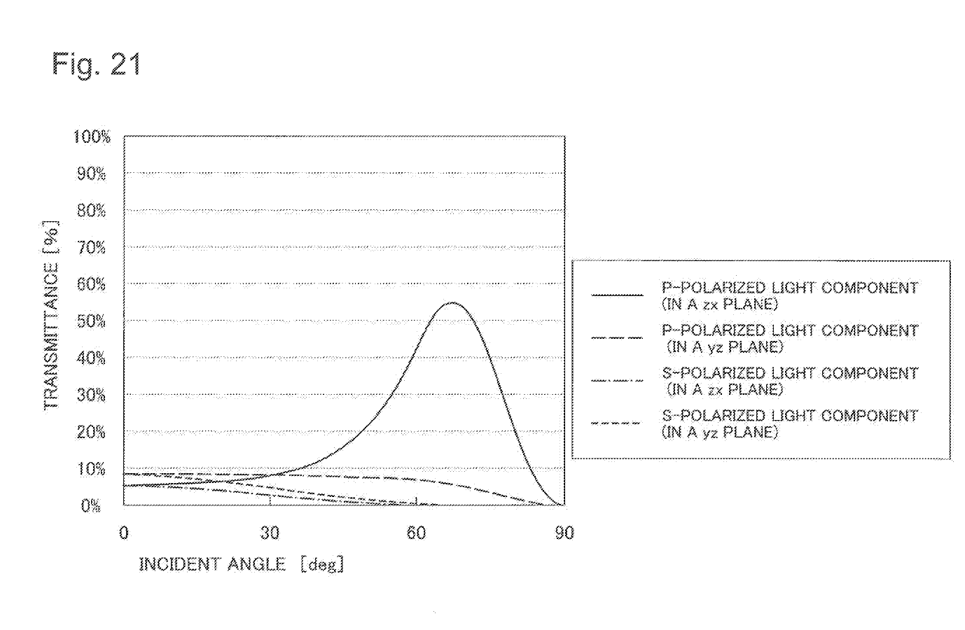

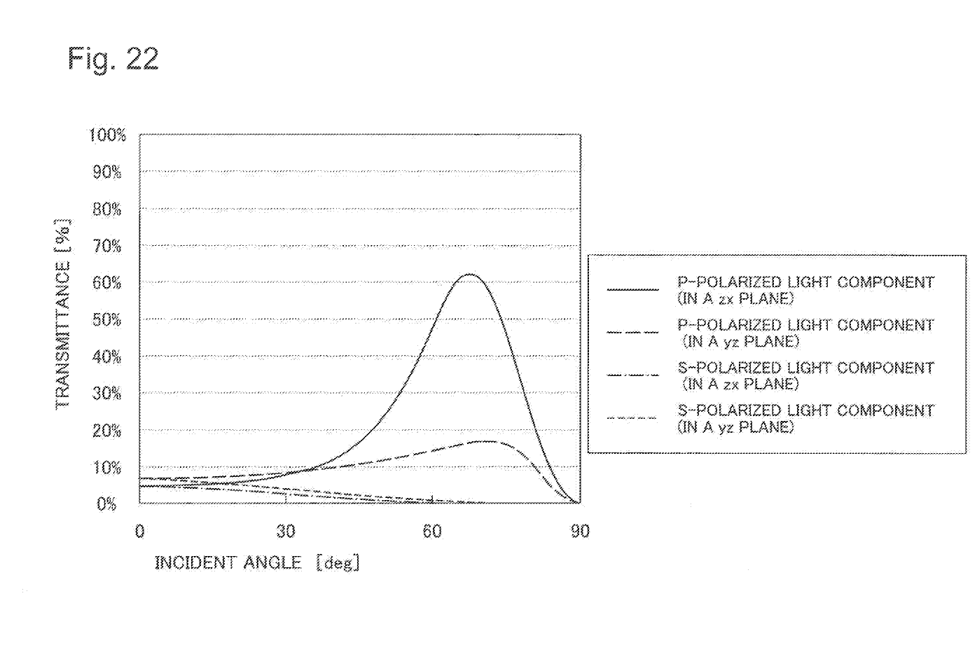

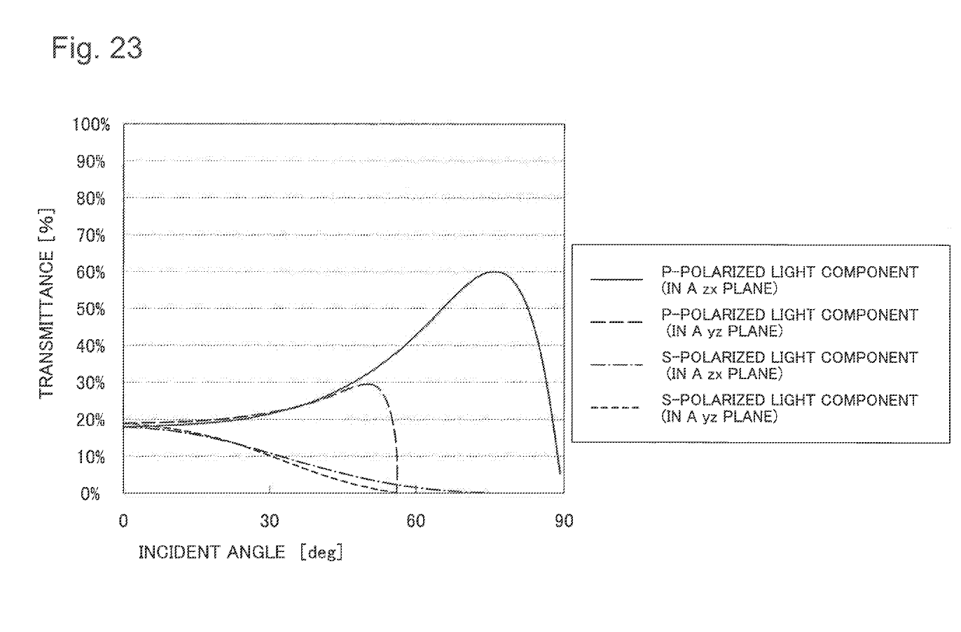

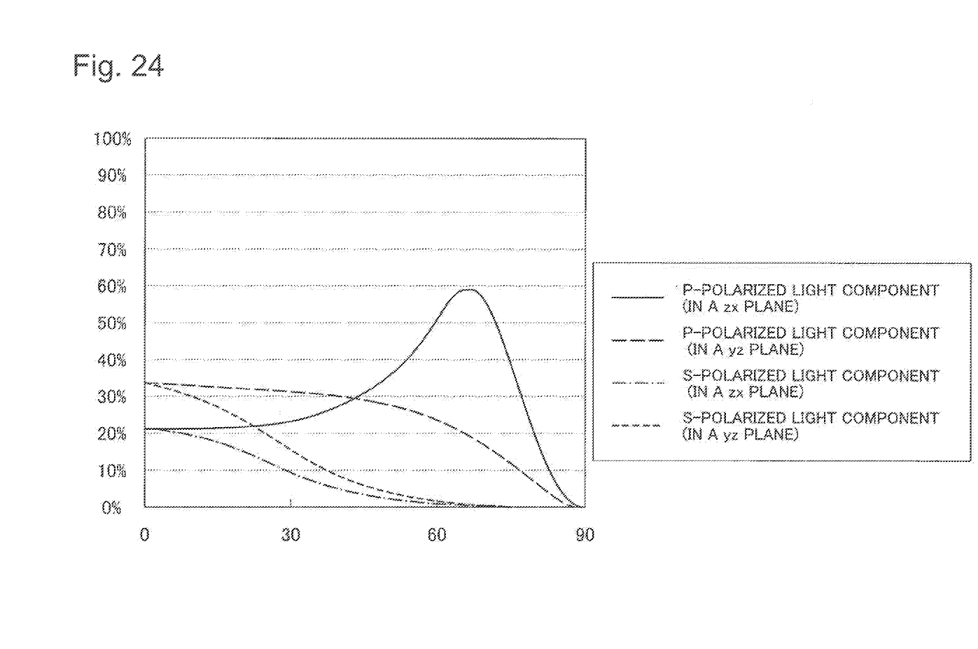

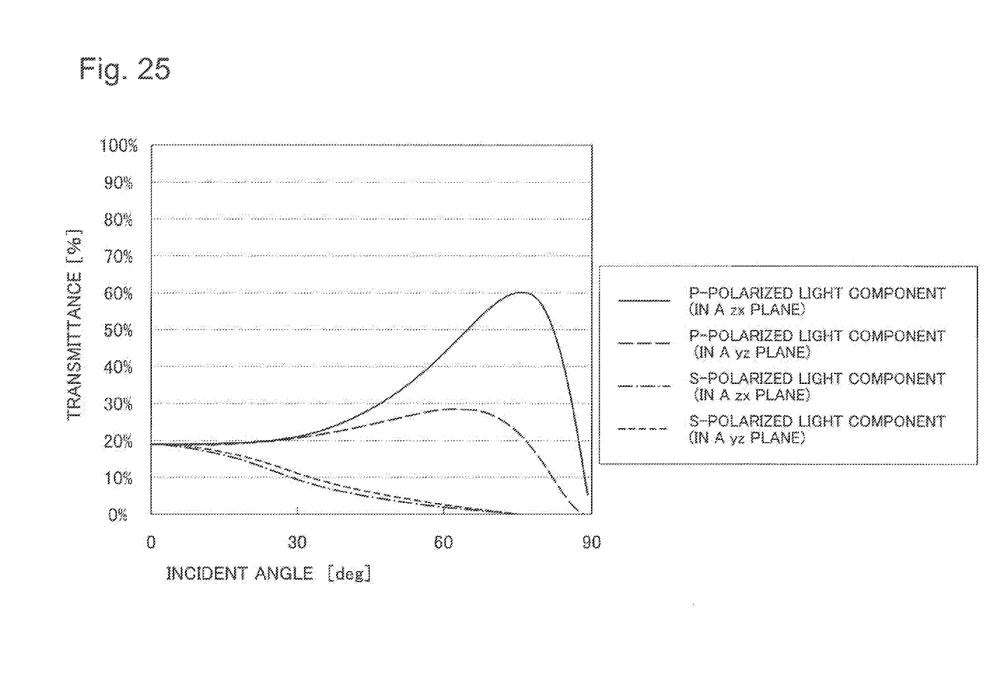

### BRIEF DESCRIPTION OF THE DRAWINGS

[FIG. 1] It is a perspective view showing an optical element of a first exemplary embodiment of the present invention schematically.

[FIG. 2A] It is an explanatory view for explaining an operation of the optical element of the first exemplary embodiment of the present invention.

[FIG. 2B] It is an explanatory view for explaining an operation of the optical element of the first exemplary embodiment of the present invention.

[FIG. 3] It is a perspective view showing an optical element of a second exemplary embodiment of the present invention schematically.

[FIG. 4A] It is an explanatory view for explaining an operation of the optical element of the second exemplary embodiment of the present invention.

[FIG. 4B] It is an explanatory view for explaining an operation of the optical element of the second exemplary embodiment of the present invention.

[FIG. 5] It is a perspective view showing an optical element of a third exemplary embodiment of the present invention schematically.

[FIG. 6A] It is an explanatory view for explaining an operation of the optical element of the third exemplary embodiment of the present invention.

[FIG. 6B] It is an explanatory view for explaining an operation of the optical element of the third exemplary embodiment of the present invention.

[FIG. 7] It is a perspective view showing an optical element of a fourth exemplary embodiment of the present invention schematically.

[FIG. 8A] It is an explanatory view for explaining an operation of the optical element of the fourth exemplary embodiment of the present invention.

[FIG. 8B] It is an explanatory view for explaining an operation of the optical element of the fourth exemplary embodiment of the present invention.

[FIG. 9] It is a perspective view showing an optical element of a fifth exemplary embodiment of the present invention schematically.

[FIG. 10A] It is an explanatory view for explaining an operation of the optical element of the fifth exemplary embodiment of the present invention.

[FIG. 10B] It is an explanatory view for explaining an operation of the optical element of the fifth exemplary embodiment of the present invention.

[FIG. 11] It is a perspective view showing an optical element of a sixth exemplary embodiment of the present invention schematically.

[FIG. 12A] It is an explanatory view for explaining an operation of the optical element of the sixth exemplary embodiment of the present invention.

[FIG. 12B] It is an explanatory view for explaining an operation of the optical element of the sixth exemplary embodiment of the present invention.

[FIG. 13] It is a perspective view showing an optical element of a seventh exemplary embodiment of the present invention schematically.

[FIG. 14A] It is an explanatory view for explaining an operation of the optical element of the seventh exemplary embodiment of the present invention.

[FIG. 14B] It is an explanatory view for explaining an operation of the optical element of the seventh exemplary embodiment of the present invention.

[FIG. 15] It is a perspective view showing an optical device of an eighth exemplary embodiment of the present invention schematically.

[FIG. 16] It is a perspective view showing an optical device of a ninth exemplary embodiment of the present invention schematically.

[FIG. 17] It is a top view showing a display device of a tenth exemplary embodiment of the present invention schematically.

[FIG. 18] It is a perspective view showing a display device of an eleventh exemplary embodiment of the present invention schematically.

[FIG. 19] It is a graph of a simulation result of example 1 according to the first exemplary embodiment of the present invention.

[FIG. 20] It is a graph of a simulation result of example 2 according to the second exemplary embodiment of the present invention.

[FIG. 21] It is a graph of a simulation result of example 3 according to the third exemplary embodiment of the present invention.

[FIG. 22] It is a graph of a simulation result of example 4 according to the fourth exemplary embodiment of the present invention.

[FIG. 23] It is a graph of a simulation result of example 5 according to the fifth exemplary embodiment of the present invention.

[FIG. 24] It is a graph of a simulation result of example 6 according to the sixth exemplary embodiment of the present invention.

[FIG. 25] It is a graph of a simulation result of example 7 according to the seventh exemplary embodiment of the present invention.

[FIG. 26] It is an explanatory view for explaining an operation of a planar lighting system of Patent Document 1.

### DESCRIPTION OF EMBODIMENTS

A desirable form for carrying out the present invention will be described using drawings below. However, although limitations technically desirable in order to carry out the present invention are performed in the exemplary embodiments described below, the scope of the invention is not limited to the followings. In the following description, similar sections having similar functions are denoted by similar reference numerals and their description will be omitted.

### First Exemplary Embodiment

FIG. 1 is a perspective view showing an optical element 101 of a first exemplary embodiment of the present invention schematically. In an actual optical element, because a thickness of each layer is very thin, and a difference in the thicknesses of each layer is large, it is difficult to illustrate each layer by an accurate scale and ratio. Therefore, in the drawing, each layer is not drawn as an actual ratio, but is shown schematically.

[Description of Structure]

A light source which is not illustrated is arranged in a peripheral part of an optical element 101 and emits randomly polarized light to the optical element 101. The light source may be arranged in a position away from the optical element 101 and it may be arranged so that the optical element 101 may be touched therewith, and may be connected with the optical element 101 optically via a light guiding member like a light pipe.

The optical element 101 includes a light-guide layer 102, a low refractive index layer 103, a metal layer 104, a birefringent layer 105 and a cover layer 106.

The light-guide layer 102, the low refractive index layer 103, the birefringent layer 105 and the cover layer 106 correspond to dielectric layers. The metal layer 104 corresponds to a metal layer. For example, the light-guide layer 102 is a sixth dielectric layer, and the low refractive index layer 103 is a second dielectric layer, and the birefringent layer 105 is a first dielectric layer, and the cover layer 106 is a fifth dielectric layer. For example, the metal layer 104 is a first metal layer.

The dielectric layer of the present invention is composed of a transparent material which transmits visible light, and acts as a medium which light propagates. The dielectric layer of the exemplary embodiment of the present invention has a specific refractive index mentioned later to visible light.

The birefringent layer of the exemplary embodiment of the present invention has optical anisotropy to visible light at least. When the optical anisotropy which the birefringent layer of the exemplary embodiment of the present invention has is caused by a birefringent material included in the birefringent layer, the birefringent layer has two different refractive indices at least.

It is assumed that directions (a first direction and a second direction) of two refractive indices which the birefringent layer of the exemplary embodiment of the present invention has are not parallel to a z-axis direction which is a lamination direction and have components in an x-axis direction and a y-axis direction which are orthogonal to the z-axis direction at least and are in-plane directions. The first direction and the second direction do not necessarily need to orthogonally intersect each other, and should just intersect in an xy plane. In the present invention, a relation between such the first direction and the second direction is called approximately orthogonal crossing.

The metal layer of the present invention is composed of a material which does not transmit visible light at least, and reflects light in a metal layer single layer. As mentioned later, the metal layer of the exemplary embodiment of the present invention is formed of a metal which can excite a surface plasmon on the surface by an evanescent light of visible light.

Light emitted from a light source enters the light-guide layer 102, and the entered light transmits inside. The light-guide layer 102 is formed of a dielectric substance with a refractive index of 2.5 or more to less than 3.0 to visible light. As an example, it is TiO2 (titanium oxide).

The refractive index of the light-guide layer 102 may be 2.2 or more, and should just be 2.5 or more to less than 3.0 preferably. When a thickness of the light-guide layer 102 is about 0.5 mm as a guide, it will function satisfactorily. However, the thickness of the light-guide layer 102 is not limited in particular. The light-guide layer 102 may have birefringence, and does not need to have birefringence. Although the shape of the light-guide layer 102 is made plate-like in the present exemplary embodiment, it may not be actually limited to the plate-like one, and it may be a wedge shape, a sawtooth waveform shape, or the like.

The numerical value range of the refractive index indicated in the description of the optical element of the exemplary embodiment of the present invention is the range in which an effect was confirmed by the RCWA method (Rigorous Coupled Wave Analysis method) used in a simulation of an example mentioned later.

The low refractive index layer 103 is a layer with a refractive index smaller than a refractive index of the light-guide layer 102 and the cover layer 106. The refractive index of the low refractive index layer 103 should just be in the range of 1.6-2.1. For example, low refractive index layer 103 is formed of a dielectric substance whose refractive index is about 1.9 to visible light. As an example, it is Y2O3 (yttrium oxide). The refractive index of the low refractive index layer 103 is not limited to about 1.9. More particularly, the refractive index of the low refractive index layer 103 may be different from 1.9 to such an extent that a surface plasmon 113 is excited at an interface between the low refractive index layer 103 and the metal layer 104, when the energy of the evanescent light 112 mentioned later generated in the low refractive index layer 103 reaches the metal layer 104.

When a thickness of the low refractive index layer 103 is about 50 nm, it will function satisfactorily. The thickness of the low refractive index layer 103 may be about 50 nm or more. More particularly, it may be approximately in a range with which the energy of the evanescent light 112 mentioned later generated in the low refractive index layer 103 reaches the metal layer 104.

The metal layer 104 is formed of a metal which can excite a surface plasmon on the surface thereof by an evanescent light of visible light. As an example, it is Ag (silver). A thickness of the metal layer 104 is about 50 nm.

The metal layer 104 is not limited to Ag, and it may be Al (aluminum) and Au (gold). More particularly, it may be one which excites a surface plasmon 113 at an interface mentioned later between the low refractive index layer 103 and the metal layer 104. The metal layer 104 may include one of Ag, Al and Au.

The thickness of the metal layer 104 should just be 200 nm or less, and it is more desirable that it is in the range of 30-100 nm. More particularly, it should just be thin to such an extent that the energy of the surface plasmon 113 mentioned later which is generated at the interface between the low refractive index layer 103 and the metal layer 104 reaches an interface between the metal layer 104 and the birefringent layer 105. It may be thick to such an extent that a light of an S polarization which does not excite a surface plasmon mentioned later is blocked out.

The thickness of the metal layer (Ag layer) indicated in the description of the optical element of the exemplary embodiment of the present invention is the thickness with which an effect was confirmed by the RCWA method (Rigorous Coupled Wave Analysis method) used by a simulation of an example.

A surface plasmon excitation means consists of the light-guide layer 102, the low refractive index layer 103 and the metal layer 104. The surface plasmon excitation means of the first exemplary embodiment is a configuration that is so-called Otto set-up. In the surface plasmon excitation means of the first exemplary embodiment, the surface plasmon 112 is excited at an interface between the low refractive index layer 103 and the metal layer 104 by an evanescent light 112 which is generated when a light which propagates in the light-guide layer 102 is totally reflected off an interface between the light-guide layer 102 and the low refractive index layer 103.

The birefringent layer 105 needs only to have optical anisotropy, and a birefringent material may be mixed with the other material. However, in order for the birefringent layer 105 to have an optical anisotropy, it is desirable that the birefringent layer 105 includes only birefringent materials.

Generally, in a non-isotropic medium having optical anisotropy such as a birefringent material, light travels at a different speed corresponding to a direction of a vibration surface of the light. Therefore, light which entered the medium including the birefringent material is refracted to two directions. The lights refracted to the two directions are divided into a normal light which vibrates vertically to a principal cross section made by an optical axis and a wave normal, and an abnormal light which vibrates in parallel thereto. While the normal light is mostly emitted on the optical axis, the abnormal light is shifted from the optical axis and emitted. A magnitude of birefringence an be detected from a phase difference of a normal light and an abnormal light, ant it becomes so large that a difference of the refractive index ne to the abnormal light and the refractive index no to the normal light is large.

The birefringent layer 105 has two different refractive indices. For example, the birefringent layer 105 is formed of a dielectric substance whose refractive index no to a normal light of visible light is about 1.9 and whose refractive index ne to an abnormal light is about 2.2. As an example, it is a YVO4 (yttrium vanadate) crystal. A thickness of the birefringent layer 105 is about 50 nm.

The no of the birefringent layer 105 is the same as the refractive index of the low refractive index layer 103. Thereby, a dielectric constant relation between the low refractive index layer 103 and the metal layer 104, and a dielectric constant relation between the dielectric constant of the birefringent layer 105 to a normal light and the metal layer 104 coincide. Thus, when the dielectric constant relations coincide, the energy of the surface plasmon 113 which was generated at the interface between the low refractive index layer 103 and the metal layer 104 can generate a surface plasmon 114 efficiently at the interface between the birefringent layer 105 and the metal layer 104. Further, the no of the birefringent layer 105 and the refractive index of the low refractive index layer 103 do not need to coincide completely. The no of the birefringent layer 105 and the refractive index of the low refractive index layer 103 should be just approximately equal to such an extent that the surface plasmon 114 can be generated by the energy of the surface plasmon 113.

Further, the no of the birefringent layer 105 may be different from the refractive index of the low refractive index layer 103. More particularly, they may be different to such an extent that the surface plasmon 114 is generated at the interface between the birefringent layer 105 and the metal layer 104 by the energy of the surface plasmon 113 mentioned later which was generated at the interface between the low refractive index layer 103 and the metal layer 104.

The ne of the birefringent layer 105 is not limited to 2.2, and it may be different. More particularly, it may be different to such an extent that a surface plasmon is not generated by the energy of the surface plasmon 113 mentioned later which was generated at an interface between the birefringent layer 105 and the metal layer 104.

Further, the thickness of the birefringent layer 105 may be about 50 nm or more. More particularly, it should be just thin to an extent that light 116 is generated in the cover layer 106 via the evanescent light 115 from the surface plasmon 114 mentioned later which was generated at the interface between birefringent layer 105 and the metal layer 104.

The cover layer 106 should just have a refractive index of 2.2 or more to visible light, and preferably is formed of a dielectric substance with that of 2.5 or more to 3.0 or less. As an example, it is TiO2 (titanium oxide). Further, the cover layer 106 may have birefringence and does not need to have the birefringence.

Further, it is desirable that the refractive index of the cover layer 106 is the same as the refractive index of the light-guide layer 102. Thereby, a refractive index relation between the light-guide layer 102 and the low refractive index layer 103, and a refractive index relation between refractive indices of the cover layer 106 and the birefringent layer 105 to a normal light coincide. Thus, when the refractive index relations coincide, light 116 can be generated efficiently from the surface plasmon 114 which was generated at the interface between the birefringent layer 105 and the metal layer 104. However, the refractive index of the cover layer 106 is not limited completely to match with the refractive index of the light-guide layer 102. The refractive index of the cover layer 106 and the refractive index of the light-guide layer 102 should be just approximately equal to such an extent that the light 116 can be generated from the surface plasmon 114.

A light generating means consists of the metal layer 104, the birefringent layer 105 and the cover layer 106. The light generating means generates the light 116 by the surface plasmon 114 which is generated at the interface between the metal layer 104 and the birefringent layer 105, and takes it out.

Further, each of the low refractive index layer, the light-guide layer and the cover layer may include any one of TiO2 and Y2O3.

For example, the optical element 101 can be produced by the following procedures.

Y2O3, Ag, YVO4 and TiO2 are formed on TiO2 by a vapor deposition method such as sputtering, or a joining method such as optical bonding. However, the manufacturing method of the optical element 101 of the first exemplary embodiment is not limited to the vapor deposition method and the joining method.

FIG. 2A and FIG. 2B are diagrams for explaining in detail an operation of the optical element 101 shown in FIG. 1.

FIG. 2A shows a cross section orthogonal to a y-axis of the optical element 101. A light A among lights which exist in the light-guide layer 102 shows a light of P polarization, that is, a light whose vibration direction of the electric field is parallel to a zx plane. A light B shows a light of S polarization, that is, a light whose vibration direction of the electric field is orthogonal to the zx plane. Further, a refractive index in the zx plane of the birefringent layer 105 is no.

FIG. 2B shows a cross section orthogonal to an x-axis of the optical element 101. A light C among lights which exist in the light-guide layer 102 shows a light of P polarization, that is, a light whose vibration direction of the electric field is parallel to a yz plane, and a light D shows a light of S polarization, that is, a light whose vibration direction of the electric field is orthogonal to the yz plane. Further, a refractive index in the yz plane of the birefringent layer 105 is ne.

[Explaining of Operation]

Next, a principle that a surface plasmon is excited and light is generated from the surface plasmon is explained.

A surface plasmon is a compressional wave of a group of electrons which propagates an interface between a metal and a dielectric substance. A dispersion relation which is a relation between a wave number and an angular frequency of the surface plasmon is determined from a dielectric constant of the metal and the dielectric substance of the interface thereof. When the dispersion relation of the surface plasmon coincides with a dispersion relation of a light which propagates in the dielectric substance, that is, when a wave number of the light in the dielectric substance becomes equal to the wave number of the surface plasmon, the surface plasmon is excited by the light.

However, only in case of an interface between metal and a dielectric substance, the dispersion relation of the surface plasmon and the dispersion relation of the light in the dielectric substance do not usually coincide. Therefore, the surface plasmon is not excited only by entering a light into the metal from the dielectric substance. Accordingly, in order to excite the surface plasmon, it is necessary to change the dispersion relation of light in the dielectric substance, and to match the dispersion relation of the surface plasmon with the dispersion relation of light in the dielectric substance.

As a method of changing a dispersion relation of light and exciting a surface plasmon, the ATR method (attenuated total reflection method) is known. The ATR method will be explained here. A light which propagates a region where a refractive index is high is totally reflected off an interface of the region where the refractive index is high, and a region where a refractive index is low, and generates an evanescent light which is caused by a magnitude relation of the refractive indices of the region where the refractive index is high, and the region where the refractive index is low. When wave numbers of the evanescent light and the surface plasmon at the interface between the region where the refractive index is low, and the metal coincide, the light will excite the surface plasmon caused by the relation of the dielectric constant between the region where the refractive index is low, and the metal at the interface between the region where the refractive index is low, and the metal.

Here, a surface plasmon is caused by a compressional wave, and an incident light which can excite a surface plasmon is a P polarization with a vibration direction of the electric field parallel to an incident surface at an interface between a region where a refractive index is high, and a region where a refractive index is low. In contrast, a light of S polarization with a vibration direction of the electric field vertical to the incident surface at the interface between the region where the refractive index is high, and the region where the refractive index is low, does not excite a surface plasmon at an interface between the region where the refractive index is low, and a metal, but it is totally reflected off the interface between the region where the refractive index is high, and the region where the refractive index is low, or is blocked out and reflected by the metal.

Accordingly, a light A of FIG. 2A, when it has a specific incident angle to the interface between the low refractive index layer 103 and the metal layer 104, excites a surface plasmon 113 which propagates at the interface between the light-guide layer 102 and the low refractive index layer 103 via an evanescent light 112 in an x direction. Here, this transition process is called an order process.

The energy of the surface plasmon 113 generated at the interface between the low refractive index layer 103 and the metal layer 104, because the metal layer 104 is thin enough, reaches an interface between the metal layer 104 and the birefringent layer 105. Here, the refractive index in the zx plane of the birefringent layer 105 is no, and is the same as the refractive index of the low refractive index layer 103. Therefore, a relation of a dielectric constant between the cover layer 106, the birefringent layer 105 and the metal layer 104 becomes equal to a relation of a dielectric constant between the light-guide layer 102, the low refractive index layer 103 and the metal layer 104, and a reversal process which is the opposite of the order process is generated.

That is, when the reversal process is generated, a surface plasmon 114 with the same wave number as the surface plasmon 113 generates at the interface between the metal layer 104 and the birefringent layer 105, and a light 116 having the same polarized light components as the light A is generated in a cover layer 106 via an evanescent light 115.

The light B, because it is a S polarization, does not generate a surface plasmon at the interface between the light-guide layer 102 and the low refractive index layer 103, and it is totally reflected off the interface between the light-guide layer 102 and the low refractive index layer 103, or it transmits through the low refractive index layer 103, and is reflected by the metal layer 104.

The light C of FIG. 2B, when it has a specific incident angle to the interface between the light-guide layer 102 and the low refractive index layer 103, excites a surface plasmon 123 which propagates at the interface between the low refractive index layer 103 and the metal layer 104 in a y direction via an evanescent light 122. The energy of the surface plasmon 123, because the metal layer 104 is thin enough, reaches the interface between the metal layer 104 and the birefringent layer 105.

Here, because the refractive index in the yz plane of the birefringent layer 105 is ne, and it is different from the refractive index of the low refractive index layer 103, the relation of the dielectric constant between the light-guide layer 102, the low refractive index layer 103 and the metal layer 104 is different from the relation of the dielectric constant between the cover layer 106, the birefringent layer 105 and the metal layer 104. Therefore, the wave number of the surface plasmon 123 and the wave number of the surface plasmon 124 are not identical, and transfer of the energy is not carried out.

The light D, because it is an S polarization, does not generate a surface plasmon at the interface between the light-guide layer 102 and the low refractive index layer 103, and it is totally reflected off the interface between the light-guide layer 102 and the low refractive index layer 103, or transmits through the low refractive index layer 103, and is reflected by the metal layer 104.

[Description of Action and Effect]

From the above, only the light A among lights which exist in the light-guide layer 102 is taken out from the cover layer 106 via the surface plasmon.

That is, when the birefringent layer 105 exists, because light can be taken out only from a surface plasmon having a specific wave number in the x direction, an emitted light having a principal component of the polarization component propagating in the zx plane which is the specified direction can be obtained.

The light-guide layer 102, the low refractive index layer 103, the metal layer 104, the birefringent layer 105 and the cover layer 106 should just be laminated toward a predetermined direction, and they should just be laminated by overlapping each other to such an extent that light is emitted from the cover layer 106 when light enters the light-guide layer 102.

Further, even when light propagating in a direction other than the zx direction enters the interface between the light-guide layer 102 and the low refractive index layer 103 at various angles, if the incident angle of the light which is projected on the zx plane is an angle which satisfies an excitation condition of a surface plasmon, a light having specific polarization component can be obtained.

In that case, first, a surface plasmon having a specific wave number in the x direction is excited by a polarization component parallel to the x direction at the interface between the low refractive index layer 103 and the metal layer 104 like the light A. The energy reaches an interface between the metal layer 104 and the birefringent layer 105, and it is taken out in the cover layer 106 as a light having specific polarization component in the x direction.

Thus, according to the first exemplary embodiment, the light 116 which has high angular selectivity and polarization selectivity, and has a polarization component of a specified direction is obtained by using the birefringent layer 105.

### Second Exemplary Embodiment

FIG. 3 is a perspective view showing an optical element of a second exemplary embodiment of the present invention schematically. The optical element 201 shown in FIG. 3, compared with an optical element 101 of the first exemplary embodiment shown in FIG. 1, is provided with a low refractive index layer 205 instead of the birefringent layer 105, and a birefringent layer 206 instead of the cover layer 106

A light-guide layer 202, low refractive index layers 203 and 205 and the birefringent layer 206 correspond to dielectric layers. A metal layer 204 corresponds to a metal layer. For example, the light-guide layer 202 is a second dielectric layer, and the low refractive index layer 203 is a fourth dielectric layer, and the low refractive index layer 205 is a third dielectric layer, and the birefringent layer 206 is a first dielectric layer. For example, the metal layer 204 is a first metal layer.

The light-guide layer 202 has the same configuration as that in the first exemplary embodiment. A refractive index of the light-guide layer 202 may be 1.9 or more. The light-guide layer 202 is formed of a dielectric substance with a refractive index of about 2.2 to visible light, for example. As an example, it is CeO2 (cerium oxide). The refractive index of the light-guide layer 202 is not limited to about 2.2.

The low refractive index layer 203 has the same configuration as that in the first exemplary embodiment. A refractive index of the low refractive index layer 203 should be in the range of 1.5-2.1. For example, it is formed of a dielectric substance with a refractive index of about 1.7 to visible light. The low refractive index layer 203 is Al2O3 (aluminum oxide) as an example, The refractive index of the low refractive index layer 203 is not limited to about 1.7.

When a thickness of the low refractive index layer 203 is about 50 nm, it will function satisfactorily. The thickness of the low refractive index layer 203 may be about 50 nm or more. More particularly, it may be approximately in a range with which the energy of the evanescent light 212 mentioned later generated in the low refractive index layer 203 reaches the metal layer 204.

The low refractive index layer 205 is composed of the same material or a material with same property as that of the low refractive index layer 203. When refractive indices of the low refractive index layer 205 and the low refractive index layer 203 are identical, a dielectric constant relation between the low refractive index layer 203 and the metal layer 204, and a dielectric constant relation between the low refractive index layer 205 and the metal layer 204 are identical. Thus, when the dielectric constant relations are identical, at an interface mentioned later between the metal layer 204 and the low refractive index layer 205, a surface plasmon 214 can be excited efficiently. Further, although it is desirable that the refractive index of the low refractive index layer 203 and the refractive index of the low refractive index layer 205 are identical, but it is not limited that they are exactly the same. The refractive index of the low refractive index layer 205 and the refractive index of the low refractive index layer 203 should be just approximately equal to such an extent that the surface plasmon 214 can be excited.

When a thickness of the low refractive index layer 205 is about 50 nm, it will function satisfactorily. And a thickness of the low refractive index layer 203 may be about 50 nm or more. More particularly, it may be approximately in a range with which the light 216 can be generated via an evanescent light 215 mentioned later from the surface plasmon 214 generated at the interface between the low refractive index layer 205 and the metal layer 204.

The birefringent layer 206 has two different refractive indices. The birefringent layer 206 is formed of a dielectric substance whose refractive index no to a normal light is about 1.9, and whose refractive index ne to an abnormal light is about 2.2. As an example, a YVO4 crystal can be used.

Further, nₒ of the birefringent layer 206 is not limited to 1.9, and it may be different. More particularly, it may be different to such an extent that the energy of the surface plasmon 213 mentioned later generated at the interface between the low refractive index layer 203 and the metal layer 204 does not generate a surface plasmon at the interface between the low refractive index layer 203 and the metal layer 204.

The ne of the birefringent layer 206 is not limited to 2.2, and it may be different. More particularly, it may be different to such an extent that the energy of the surface plasmon 213 mentioned later generated at the interface between the low refractive index layer 203 and the metal layer 204 generates a surface plasmon at the interface between the low refractive index layer 205 and the metal layer 204.

FIG. 4A and FIG. 4B are diagrams for explaining in detail an operation of the optical element 201 shown in FIG. 3.

FIG. 4A shows a cross section orthogonal to a y-axis of the optical element 201. A light A shows a light of P polarization, that is, a light whose vibration direction of the electric field is parallel to a zx plane, in lights which exist in the light-guide layer 202. A light B shows a light of S polarization, that is, a light whose vibration direction of the electric field is orthogonal to the zx plane. Further, a refractive index in the zx plane of the birefringent layer 206 is ne.

FIG. 4B shows a cross section orthogonal to an x-axis of the optical element 201. A light C among lights which exist in the light-guide layer 202 shows a light of P polarization, that is, a light whose vibration direction of the electric field is parallel to a yz plane. A light D shows a light of S polarization, that is, a light whose vibration direction of the electric field is orthogonal to the yz plane. Further, a refractive index in the yz plane of the birefringent layer 206 is no.

Next, a principle that a surface plasmon is excited and light is generated from the surface plasmon is explained.

The operations of the light B of FIG. 4A and the light D of FIG. 4B are the same as those in the first exemplary embodiment, and their descriptions will be omitted.

The light A of FIG. 4A, when it has a specific incident angle to the interface between the light-guide layer 202 and the low refractive index layer 203, excites a surface plasmon 213 which propagates at the interface between the low refractive index layer 203 and the metal layer 204 in an x direction via the evanescent light 212. Here, this transition process is called an order process. Further, the order process of the second exemplary embodiment is the same process as the order process of the first exemplary embodiment.

The energy of the surface plasmon 213, because the metal layer 204 is thin enough, reaches the interface between the metal layer 204 and the low refractive index layer 205.

Here, a refractive index in the zx plane of the birefringent layer 206 is ne, and it is the same as the refractive index of the light-guide layer 202. Therefore, a relation of a dielectric constant between the light-guide layer 202, the low refractive index layer 203 and the metal layer 204 becomes equal to a relation of a dielectric constant between the birefringent layer 206, the low refractive index layer 205 and the metal layer 204, and a reversal process which is the opposite of the order process is generated. Further, the reversal process of the second exemplary embodiment is the same process as the reversal process of the first exemplary embodiment.

That is, when the reversal process is generated, a surface plasmon 214 with the same wave number as the surface plasmon 213 is generated at the interface between the metal layer 204 and the low refractive index layer 205, and it generates a light 216 which propagates in the zx plane in the birefringent layer 206 via an evanescent light 215.

The ne of the birefringent layer 206 and the refractive index of the light-guide layer 202 do not need to coincide completely. The ne of the birefringent layer 206 and the refractive index of the light-guide layer 202 should be just approximately equal to such an extent that the surface plasmon 214 generates the light 216 via the evanescent light 215.

Light C of FIG. 4B, when it has a specific incident angle to the interface between the light-guide layer 202 and the low refractive index layer 203, excites a surface plasmon 223 which propagates the interface between the low refractive index layer 203 and the metal layer 204 in a y direction via an evanescent 222. The energy of the surface plasmon 223 generated at the interface between the low refractive index layer 203 and the metal layer 204, because the metal layer 204 is thin enough, reaches the interface between the metal layer 204 and the low refractive index layer 205.

Here, the refractive index in the yz plane of the birefringent layer 206 is no, and it is different from the refractive index of the light-guide layer 202. Therefore, the relation of the dielectric constant between the light-guide layer 202, the low refractive index layer 203, and the metal layer 204 is different from the relation of the dielectric constant between the birefringent layer 206, the low refractive index layer 205 and the metal layer 204. Accordingly, light cannot be generated via an evanescent light from a surface plasmon 224 generated at the interface between the low refractive index layer 205 and the metal layer 204.

That is, when the birefringent layer 206 exists, because light can be taken out only from a surface plasmon having a specific wave number in the x direction, an emitted light having as a principal component the polarization component propagating in the zx plane.

Thus, according to the second exemplary embodiment, although the cover layer 106 and the birefringent layer 105 of the first exemplary embodiment were replaced with the birefringent layer 206 and the low refractive index layer 205 respectively, the light 216 having high angular selectivity and polarization selectivity, and having a polarization component of a specified direction like the first exemplary embodiment is obtained.

### Third Exemplary Embodiment

FIG. 5 is a perspective view showing an optical element 301 of a third exemplary embodiment of the present invention schematically. The optical element 301 shown in FIG. 5 is provided with a birefringent layer 303 instead of the low refractive index layer 103 compared with the optical element 101 of the first exemplary embodiment shown in FIG. 1.

A light-guide layer 302, birefringent layers 303 and 305 and a cover layer 306 correspond to dielectric layers. A metal layer 304 corresponds to a metal layer. For example, the light-guide layer 302 is a sixth dielectric layer, and the birefringent layer 303 is a second dielectric layer, and the birefringent layer 305 is a first dielectric layer, and the cover layer 306 is a fifth dielectric layer. For example, a metal layer 304 is a first metal layer.

The birefringent layers 303 and 305 have two different refractive indices. The birefringent layer 303 is composed of the same material and a material with the same property as the birefringent layer 305. The birefringent layer 303 may be different from the birefringent layer 305. More particularly, it may be different to such an extent that a surface plasmon 313 is excited by a light A of P polarization mentioned later in a zx plane at an interface between the birefringent layer 303 and the metal layer 304, and a surface plasmon is not excited by a light C of P polarization in a zx plane at an interface between the birefringent layer 303 and the metal layer 304.

FIG. 6A and FIG. 6B are diagrams for explaining in detail an operation of the optical element 301 shown in FIG. 5.

FIG. 6A shows a cross section orthogonal to a y-axis of the optical element 301. A light A among lights which exist in the light-guide layer 302 shows a light of P polarization, that is, a light whose vibration direction of the electric field is parallel to a zx plane. A light B shows a light of S polarization, that is, a light whose vibration direction of the electric field is orthogonal to the zx plane. Refractive indices of the birefringent layers 303 and 305 in the zx plane are no.

FIG. 6B shows a cross section orthogonal to an x-axis of the optical element 301. A light C among lights which exist in the light-guide layer 302 shows a light of P polarization, that is, a light whose vibration direction of the electric field is parallel to a yz plane. A light D shows a light of S polarization, that is, a light whose vibration direction of the electric field is orthogonal to the yz plane. A refractive index of the birefringent layers 303 and 305 in the yz plane is ne.

Next, a principle that a surface plasmon is excited and light is generated from the surface plasmon is explained.

The operations of the light A of FIG. 6A, the light B and the light D of FIG. 6B are the same as those of the first exemplary embodiment, and descriptions thereof will be omitted. Evanescent lights 312 and 315 and surface plasmons 313 and 314 in FIG. 6A and FIG. 6B are not used in the description of this exemplary embodiment.

As for the light C of FIG. 6B, when totally reflected off an interface between the light-guide layer 302 and the birefringent layer 303 and generating an evanescent light 322, the wave number of the evanescent light 322 and the wave number of the surface plasmon at an interface between the birefringent layer 303 and the metal layer 304 are not identical. Therefore, the light C does not excite a surface plasmon and returns to the light-guide layer 302 or transmits through the birefringent layer 303, and is reflected in a metal layer 304.

That is, when the birefringent layers 303 and 305 exist, because light can be taken out only from a surface plasmon having a specific wave number in the x direction, an emitted light having a principal component of the polarization component propagating in the zx plane which is the specified direction can be obtained.

The optical element 301 of the third exemplary embodiment, compared with the optical element 101 of the first exemplary embodiment, can reduce a loss by suppressing excitation of a surface plasmon which does not contribute to optical extraction. Therefore, when using it in combination with a phase modulation means and a reflective means mentioned later, use efficiency of light can be raised.

Thus, according to the third exemplary embodiment, although the low refractive index layer 103 of the first exemplary embodiment was replaced with the birefringent layer 303, the light 316 having high angular selectivity and polarization selectivity, and having a polarization component of a specified direction is obtained like the first exemplary embodiment.

### Fourth Exemplary Embodiment

FIG. 7 is a perspective view showing an optical element 401 of a fourth exemplary embodiment of the present invention schematically. The optical element 401 shown in FIG. 7, compared with the optical element 201 of the second exemplary embodiment shown in FIG. 3, is provided with a birefringent layer 402 instead of the light-guide layer 202.

Further, birefringent layers 402 and 406 and low refractive index layers 403 and 405 correspond to dielectric layers. And, a metal layer 404 corresponds to a metal layer. For example, the birefringent layer 402 is a second dielectric layer, and the low refractive index layer 403 is a fourth dielectric layer, and the low refractive index layer 405 is a third dielectric layer, and the birefringent layer 406 is a first dielectric layer. For example, the metal layer 404 is a first metal layer.

The birefringent layers 402 and 406 have two different refractive indices. The birefringent layer 402 is composed of the same material and a material with the same property as the birefringent layer 406. The birefringent layer 402 may be different from the birefringent layer 406. More particularly, it may be different to such an extent that a surface plasmon 413 is excited by a light A of P polarization mentioned later in a zx plane at an interface between the birefringent layer 403 and the metal layer 404, and a surface plasmon is not excited by a light C of P polarization in a zx plane at an interface between the birefringent layer 403 and the metal layer 404.

FIG. 8A and FIG. 8B are diagrams for explaining in detail an operation of the optical element 401 shown in FIG. 7.

FIG. 8A shows a cross section orthogonal to a y-axis of the optical element 401. A light A among lights which exist in the birefringent layer 402 shows a light of P polarization, that is, a light whose vibration direction of the electric field is parallel to a zx plane. A light B shows a light of S polarization, that is, a light whose vibration direction of the electric field is orthogonal to the zx plane. Refractive indices of the birefringent layers 402 and 406 in the zx plane are ne.

FIG. 8B shows a cross section orthogonal to the x-axis of the optical element 401. A light C among lights which exist in the birefringent layer 402 shows a light of P polarization, that is, a light whose vibration direction of the electric field is parallel to a yz plane. A light D shows a light of S polarization, that is, a light whose vibration direction of the electric field is orthogonal to the yz plane. A refractive index of the birefringent layers 402 and 406 in the yz plane is no.

Next, a principle that a surface plasmon is excited and light is generated from the surface plasmon is explained.

The operations of the light A and the light B of FIG. 8A, the light D of FIG. 8B are the same as those of the second exemplary embodiment, and descriptions thereof will be omitted. Evanescent lights 412 and 415 and surface plasmons 413 and 414 in FIG. 8A and FIG. 8B are not used in the description of this exemplary embodiment.

When the light C of FIG. 8B is totally reflected off the interface between the birefringent layer 402 and the low refractive index layer 403, and generates an evanescent light 422, the wave number of the evanescent light 422 and the wave number of a surface plasmon at the interface between the low refractive index layer 403 and the metal layer 404 do not coincide, and it does not excite the surface plasmon. Therefore, the light C returns to the birefringent layer 402 or transmits through the low refractive index layer 403 and is reflected by the metal layer 404.

That is, when the birefringent layers 402 and 406 exist, because light can be taken out only from the surface plasmon propagating in the x direction, a polarization component which propagates in the zx plane that is the specified direction can be obtained as an emitted light.

The optical element 401 of the fourth exemplary embodiment, compared with the optical element 202 of the second exemplary embodiment, can reduce a loss by suppressing excitation of a surface plasmon which does not contribute to optical extraction. Therefore, when using it in combination with a phase modulation means and a reflective means mentioned later, use efficiency of light can be raised like the third exemplary embodiment.

Thus, according to the fourth exemplary embodiment, although the light-guide layer 202 in the second exemplary embodiment was replaced to the birefringent layers 402, the light 416 having high angular selectivity and polarization selectivity, and having a polarization component of a specified direction is obtained like the second exemplary embodiment.

### Fifth Exemplary Embodiment

FIG. 9 is a perspective view showing an optical element 501 of a fifth exemplary embodiment of the present invention schematically. The optical element of the fifth exemplary embodiment shown in FIG. 9, unlike the optical elements of the first to the fourth exemplary embodiments, includes two layers formed of a metal.

A light source which is not illustrated is arranged in a peripheral part of the optical element 501 and emits randomly polarized light to the optical element 501. The light source may be arranged in a position away from the optical element 501 and it may be arranged so that the optical element 501 may be touched therewith, and may be connected with the optical element 501 optically via a light guiding member like a light pipe.

The optical element 501 includes a light-guide layer 502, a metal layer 503, a low refractive index layer 504, a metal layer 505 and a birefringent layer 506.

The light-guide layer 502, the low refractive index layer 504 and the birefringent layer 506 correspond to dielectric layers. The above-mentioned dielectric layers include a metal layer 505 between the low refractive index layer 504 and the birefringent layer 506. The metal layer 503 corresponds to a metal layer. For example, the light-guide layer 502 is a second dielectric layer, and the low refractive index layer 504 is an eighth dielectric layer, and the birefringent layer 506 is a first dielectric layer. And, for example, the metal layer 503 is a third metal layer, and the metal layer 505 is a first metal layer.

The light-guide layer 502 is the same configuration as the first exemplary embodiment, and light emitted from a light source is incident, and the incident light transmits therein. A refractive index of the light-guide layer 502 may be 2.1 or more. The light-guide layer 502 is formed of a dielectric substance with a refractive index of about 2.2 to visible light, for example. As an example, it is CeO2. The refractive index of the light-guide layer 502 is not limited to about 2.2. The light-guide layer 502 may have birefringence, and may have no birefringence. Further, although the shape of the light-guide layer 502 is made plate-like in this exemplary embodiment, it is not limited to the plate-like one actually, and it may be a shape of a wedge shape, a sawtooth wave shape, or the like.

The metal layers 503 and 505 are formed of a metal which can excite a surface plasmon on the surface thereof by an evanescent light of visible light like the first exemplary embodiment. It is Ag (silver), as an example. The metal layers 503 and 505 are not limited to Ag, and they may be Al (aluminum), or Au (gold). More particularly, they may be ones which excite a surface plasmon 513 mentioned later at an interface between the metal layer 503 and the low refractive index layer 504.

A thickness of the metal layer 503 may be 100 nm or less, and more preferably, it may be a range of 12.5 to 50 nm. A thickness of the metal layer 505 may be 50 nm or less, and more preferably, it may be 25 nm or less. When the thickness of the metal layers 503 and 505 is about 25 nm, an advantageous effect the exemplary embodiment of the present invention can be obtained. More particularly, the thickness of the metal layers 503 and 505 should be just thin to such an extent that the energy of a surface plasmon 513 mentioned later generated at the interface between the metal layer 503 and the low refractive index layer 504 reaches the interface between the low refractive index layer 504 and the metal layer 505 and generates light 516 in the birefringent layer 506. Or dielectric constants of the metal layer 503 and the metal 505 should be just close to such an extent that the above mentioned light 516 is generated.

The thickness of the metal layers 503 and 505 may be about 10 nm. In detail, the thickness of the metal layers 503 and 505 may be thick to such an extent that a light of S polarization which does not excite a surface plasmon mentioned later is blocked out. Or the dielectric constants of the metal layer 503 and the metal layer 505 may be different to such an extent that the above mentioned the light of S polarization is blocked out.

And, the metal layer 503 may be different from the metal layer 505. The dielectric constant of the metal layer 503 and the dielectric constant of the metal layer 505 should be just approximately equal to such an extent that a surface plasmon 514 is excited by the surface plasmon 513, as mentioned later.

The low refractive index layer 504 is a layer with a refractive index smaller than that of the light-guide layer 502. The refractive index of the low refractive index layer 504 should just be in the range of 1.6-1.8. The low refractive index layer 504 is formed of a dielectric substance with a refractive index of about 1.7 to visible light, for example. As an example, it is Al2O3. The refractive index of the low refractive index layer 504 is not limited to about 1.7. More particularly, it may be approximately in a range with which a surface plasmon is excited via the evanescent 513 at the interface mentioned later between the metal layer 503 and the low refractive index layer 504.

When a thickness of the low refractive index layer 504 is about 50 nm, an advantageous effect of the exemplary embodiment of the present invention can be obtained. The thickness of the low refractive index layer 504 may be 50 nm or more. More particularly, it may be made thick nearly enough for the energy of the surface plasmon 513 mentioned later generated at the interface between the metal layer 503 and the low refractive index layer 504 to reach the interface between the low refractive index layer 504 and the metal layer 505.

A surface plasmon excitation means consists of the light-guide layer 502, the metal layer 503 and the low refractive index layer 504. The surface plasmon excitation means of the fifth exemplary embodiment is a configuration that is so-called Kretschmann configuration. A surface plasmon 513 is excited at the interface between the metal layer 503 and the low refractive index layer 504 by an evanescent light 512 which is generated when a light which propagates in the light-guide layer 502 is totally reflected off the interface between the light-guide layer 502 and the metal layer 503.

The birefringent layer 506 has two different refractive indices. For example, the birefringent layer 506 is formed of a dielectric substance whose refractive index no to a normal light is about 1.9, and whose refractive index ne to an abnormal light is about 2.2. As an example, it is an YVO4 (yttrium vanadate) crystal.

Further, nₒ of the birefringent layer 506 is not limited to about 1.9, and it may be different. More particularly, it may be different to such an extent that the energy of the surface plasmon 514 mentioned later generated at the interface between the low refractive index layer 504 and the metal layer 505 generates a light 516 in the birefringent layer 506.

The ne of the birefringent layer 506 is not limited to 2.2, and it may be different. More particularly, it may be different to such an extent that the energy of the surface plasmon 514 which was generated at the interface between the low refractive index layer 504 and the metal layer 505 does not generate light in the birefringent layer 506.

A light generating means consists of the low refractive index layer 504, the metal layer 505 and the birefringent layer 506. The light generating means generates the light 516 by the surface plasmon 514 which is generated at the interface between the low refractive index layer 504 and the metal layer 505, and takes it out.

The optical element 501 can be manufactured by the following procedures, for example.

Ag, Al2O3, Ag and YVO4 are formed on CeO2 by a vapor deposition method such as sputtering, or a joining method such as optical bonding. However, the manufacturing method of the optical element 501 of the fifth exemplary embodiment is not limited to the vapor deposition method or the joining method.

FIG. 10A and FIG. 10B are diagrams for explaining in detail an operation of the optical element 501 shown in FIG. 9.

FIG. 10A shows a cross section orthogonal to the y-axis of the optical element 501. A light A among lights which exist in the light-guide layer 502 shows a light of P polarization, that is, a light whose vibration direction of the electric field is parallel to a zx plane. A light B shows a light of S polarization, that is, a light whose vibration direction of the electric field is orthogonal to the zx plane. A refractive index in the zx plane of the birefringent layer 506 is no.

FIG. 10B shows a cross section orthogonal to an x-axis of the optical element 501. A light C among lights which exist in the light-guide layer 502 shows a light of P polarization, that is, a light whose vibration direction of the electric field is parallel to a yz plane. A light D shows a light of S polarization, that is, a light whose vibration direction of the electric field is orthogonal to the yz plane. A refractive index of the birefringent layer 506 in the yz plane is ne.

Next, a principle that a surface plasmon is excited and light is generated from the surface plasmon is explained.

The light A of FIG. 10A, when it has a specific incident angle to the interface between the light-guide layer 502 and the metal layer 503, excites a surface plasmon 513 which propagates at the interface between the metal layer 503 and the low refractive index layer 504 in an x direction via the evanescent light 512. Here, this transition process is called an order process.

The energy of the surface plasmon 513 generated at the interface between the metal layer 503 and the low refractive index layer 504, because the low refractive index layer 504 is thin enough, reaches the interface between the low refractive index layer 504 and the metal layer 505. Here, because the metal layer 503 and the metal layer 505 are the same materials, a relation of a dielectric constant between the light-guide layer 502, the metal layer 504, and the low refractive index layer 504 becomes equal to a relation of a dielectric constant between the birefringent layer 506, the metal layer 505, and the low refractive index layer 504, and a reversal process which is the opposite of the order process is generated.

That is, when the reversal process is generated, a surface plasmon 514 with the same wave number as the surface plasmon 513 is generated at the interface between the low refractive index layer 504 and the metal layer 505, and it generates a light 516 which propagates in the zx plane in the birefringent layer 506 via an evanescent light 515.

Further, the ne of the birefringent layer 506 and the refractive index of the light-guide layer 502 do not need to coincide completely. The ne of the birefringent layer 506 and the refractive index of the light-guide layer 502 should be just approximately equal to such an extent that the surface plasmon 514 excited by the surface plasmon 513 can generate the light via the evanescent light 515.

The light B, because it is a S polarization, does not generate a surface plasmon at the interface between the metal layer 503 and the low refractive index layer 504, and it is reflected by the metal layer 503.

The light C of FIG. 10B, when it has a specific incident angle to the interface between the light-guide layer 502 and the metal layer 503, excites a surface plasmon 523 which propagates at the interface between the metal layer 503 and the low refractive index layer 504 in a y direction via the evanescent light 522.

The energy of the surface plasmon 523, because the low refractive index layer 504 is thin enough, reaches the interface between the low refractive index layer 504 and the metal layer 505, and excites a surface plasmon 524.

Here, because a refractive index in a yz plane of the birefringent layer 506 is no, and it is different from the refractive index of the light-guide layer 502, a relation of a dielectric constant between the light-guide layer 502, the metal layer 503, and the low refractive index layer 504 is different from a relation of a dielectric constant between the birefringent layer 506, the metal layer 505, and the low refractive index layer 504. Therefore, light cannot be generated from the surface plasmon 524.

And, the light D, because it is a S polarization, does not generate a surface plasmon at the interface between the light-guide layer 502 and the metal layer 503, and is reflected by the metal layer 503.

From the above, only the light A among lights which exist in the light-guide layer 502 is taken out via the surface plasmon.

That is, when the birefringent layer 506 exists, because light can be taken out only from the surface plasmon propagating in the x direction, an emitted light having a principal component of the polarization component propagating in the zx plane which is the specified direction can be obtained.

Even when a light propagating in other than the x direction enters the interface between the light-guide layer 502 and the metal layer 503, if an incident angle of a projection light of the light projected on the zx plane is an angle which satisfies an excitation condition of a surface plasmon, a light having a polarization component of a specified direction can be obtained. In that case, first, a surface plasmon having a specific wave number in the x direction is excited by a polarization component parallel to the x direction at the interface between the metal layer 503 and the low refractive index layer 504 like the light A. As a result, the energy reaches the interface between the low refractive index layer 504 and the metal layer 505, and it is taken out as a light which has a polarization component specific to the x direction in the birefringent layer 506.

Thus, although the optical element 501 of the fifth exemplary embodiment is different from the optical element 101 of the first exemplary embodiment, and includes the two-layer metal layer, the light 516 having high angular selectivity and polarization selectivity, and having a polarization component of a specified direction is obtained like the first exemplary embodiment.

### Sixth Exemplary Embodiment

FIG. 11 is a perspective view showing an optical element 601 of a sixth exemplary embodiment of the present invention schematically. The optical element 601 shown in FIG. 11 is provided with a birefringent layer 604 instead of the low refractive index layer 504 and a cover layer 606 instead of the birefringent layer 506 compared with the optical element 501 of the fifth exemplary embodiment shown in FIG. 9.

A light-guide layer 602, the birefringent layer 604 and the cover layer 606 correspond to dielectric layers. The above-mentioned dielectric layers include a metal layer 605 between the birefringent layer 604 and the cover layer 606. A metal layer 503 corresponds to a metal layer. For example, the light-guide layer 602 is a second dielectric layer, and the birefringent layer 604 is a first dielectric layer, and the cover layer 606 is a seventh dielectric layer. For example, the metal layer 603 is a first metal layer, and the metal layer 605 is a second metal layer.

The birefringent layer 604 has two different refractive indices. For example, the birefringent layer 604 is formed of a dielectric substance whose refractive index no to a normal light of visible light is about 1.9, and whose refractive index ne to an abnormal light is about 2.2. As an example, it is a YVO4 crystal.

Further, nₒ of the birefringent layer 604 is not limited to 1.9, and it may be different. More particularly, it may be different to such an extent that the energy of a surface plasmon 613 mentioned later which was generated at an interface between the metal layer 605 and the cover layer 604 generates a surface plasmon 614 at an interface between the metal layer 603 and the birefringent layer 604.

The ne of the birefringent layer 604 is not limited to 2.2, and it may be different. More particularly, it may be different to such an extent that it does not generate a surface plasmon mentioned later at an interface between the metal layer 603 and the birefringent layer 604.

A thickness of the birefringent layer 604 may be 50 nm or more. More particularly, it may be made thick nearly enough for the energy of the surface plasmon 613 mentioned later generated at the interface between the metal layer 603 and the birefringent layer 604 to reach the interface between the birefringent layer 604 and the metal layer 605.

The cover layer 606 is composed of the same material and a material with the same property as the light-guide layer 602. Thereby, a refractive index relation between the light-guide layer 602 and the birefringent layer 604, and a refractive index relation between the cover layer 606 and the birefringent layer 604 coincide. Accordingly, light 616 can be generated efficiently from the surface plasmon 614 which was generated at the interface between the birefringent layer 604 and the metal layer 605. The refractive index of the cover layer 606 is larger than the no of the birefringent layer 604. The refractive index of the cover layer 606 is not limited to that it is identical with that of the light-guide layer 602. The refractive index of the cover layer 606 and the refractive index of the light-guide layer 602 should be just approximately equal to such an extent that the light 616 can be generated from the surface plasmon 614.

The refractive indices of the light-guide layer 602 and the cover layer 606 may be 2.6 or more.

A thickness of the metal layer 603 may just be 100 nm or less, and more preferably, it may be 25 nm or less. A thickness of the metal layer 605 may just be 50 nm or less, and more preferably, it may be in the range of 12.5-50 nm.

FIG. 12A and FIG. 12B are diagrams for explaining in detail an operation of the optical element 601 shown in FIG. 11.

FIG. 12A shows a cross section orthogonal to a y-axis of the optical element 601. A light A among lights which exist in light-guide layer 602 shows a light of P polarization, that is, a light whose vibrating direction of the electric field is parallel to the zx plane. A light B shows a light of S polarization, that is, a light whose vibrating direction of the electric field is orthogonal to the zx plane. A refractive index in the zx plane of the birefringent layer 604 is no.

FIG. 12B shows a cross section orthogonal to an x-axis of the optical element 601. A light C among lights which exist in the birefringent layer 602 shows a light of P polarization, that is, a light whose vibration direction of the electric field is parallel to a yz plane. A light D shows a light of S polarization, that is, a light whose vibration direction of the electric field is orthogonal to the yz plane. A refractive index in the yz face of the birefringent layer 604 is ne.

Next, a principle that a surface plasmon is excited and light is generated from the surface plasmon is explained.

The operations of the light B of FIG. 12A and the light D of FIG. 12B are the same as those of the fifth exemplary embodiment, and descriptions thereof will be omitted.

The light A of FIG. 12A, when it has a specific incident angle to the interface between the light-guide layer 602 and the metal layer 603, excites a surface plasmon 613 which propagates at the interface between the metal layer 603 and the birefringent layer 604 in an x direction via the evanescent light 612. Here, this transition process is called an order process.

The energy of the surface plasmon 613, because the birefringent layer 604 is thin enough, reaches the interface between the birefringent layer 604 and the metal layer 605. Here, because the refractive index of the light-guide layer 602 is identical with that of the cover layer 606, a relation of a dielectric constant between the light-guide layer 602, the metal layer 603, and the birefringent layer 604 becomes equal to a relation of a dielectric constant between the cover layer 606, the metal layer 605, and the birefringent layer 604, and a reversal process which is the opposite of the order process is generated.

That is, when the reversal process is generated, a surface plasmon 614 with the same wave number as the surface plasmon 613 is generated at the interface between the birefringent layer 604 and the metal layer 605, and it generates a light 616 which has the same polarization component as that of the light A via an evanescent light 615.

Further, the dielectric constant of the metal layer 603 and the dielectric constant of the metal layer 605 do not need to coincide completely. The dielectric constant of the metal layer 603 and the dielectric constant of the metal layer 605 should be just approximately equal to such an extent that a surface plasmon 614 is excited by the surface plasmon 613.

And, when the light C of FIG. 12B is totally reflected off the interface between the light-guide layer 602 and the metal layer 603, and generates an evanescent light 622, the wave number of the evanescent light 622 and the wave number of a surface plasmon at the interface between the metal layer 603 and the birefringent layer 604 do not coincide, and it does not excite the surface plasmon, and it is reflected by the metal layer 603.

And a loss can reduced by suppressing excitation of a surface plasmon which does not contribute to optical extraction compared with the fifth exemplary embodiment, and use efficiency of light can be improved when using it in combination with a phase modulation means and a reflective means mentioned later.

That is, when the birefringent layer 604 exists, because light can be taken out only from the surface plasmon propagating in the x direction, an emitted light having a principal component of the polarization component propagating in the zx plane which is the specified direction can be obtained.

The light-guide layer 602 and the cover layer 606 may have birefringence.

Thus, according to the sixth exemplary embodiment, although the low refractive index layer 504 and the birefringent layer 506 in the fifth exemplary embodiment were replaced to the cover layer 606 and the birefringent layer 604 respectively, the light 616 having high angular selectivity and polarization selectivity, and having a polarization component of a specified direction is obtained like the fifth exemplary embodiment.

### Seventh Exemplary Embodiment

FIG. 13 is a perspective view showing an optical element 701 of a seventh exemplary embodiment of the present invention schematically. The optical element 701 shown in FIG. 13 is provided with a birefringent layer 702 instead of the light-guide layer 502 compared with the optical element 501 of the fifth exemplary embodiment shown in FIG. 9.

Birefringent layers 702 and 706 and a low refractive layer 704 correspond to dielectric layers. The above-mentioned dielectric layers include a metal layer 705 between the low refractive layer 704 and the birefringent layer 706. A metal layer 703 corresponds to a metal layer. For example, the birefringent layer 702 is a second dielectric layer, and the low refractive index layer 704 is an eighth dielectric layer, and the birefringent layer 706 is a first dielectric layer. For example, the metal layer 703 is a third metal layer, and the metal layer 705 is a first metal layer.

The birefringent layer 702 has two different refractive indices. The birefringent layer 702 is composed of the same material and a material with the same property as the birefringent layer 706. Further, the birefringent layer 702 may be different from the birefringent layer 706. More particularly, it may be different to such an extent that a surface plasmon 713 mentioned later is excited by a light A of P polarization in a zx plane at an interface between the metal layer 703 and the low refractive index layer 704, and a surface plasmon is not excited by a light C of P polarization in a zx plane at an interface between the metal layer 703 and the low refractive index layer 704.

FIG. 14A and FIG. 14B are diagrams for explaining in detail an operation of the optical element 701 shown in FIG. 13.

FIG. 14A shows a cross section orthogonal to a y-axis of the optical element 701. A light A among lights which exist in the birefringent layer 702 shows a light of P polarization, that is, a light whose vibration direction of the electric field is parallel to a zx plane. A light B shows a light of S polarization, that is, a light whose vibration direction of the electric field is orthogonal to the zx plane. Refractive indices of the birefringent layers 702 and 706 in the zx plane are ne.

FIG. 14B shows a cross section orthogonal to an x-axis of the optical element 701. A light C among lights which exist in the birefringent layer 702 shows a light of P polarization, that is, a light whose vibration direction of the electric field is parallel to a yz plane. A light D shows a light of S polarization, that is, a light whose vibration direction of the electric field is orthogonal to the yz plane. Refractive indices of the birefringent layers 702 and 706 in the yz plane are no.

Next, a principle that a surface plasmon is excited and light is generated from the surface plasmon is explained.

The operations of the light A and the light B of FIG. 14A and the light D of FIG. 14B are the same as those of the fifth exemplary embodiment, and descriptions thereof will be omitted. Evanescent lights 712 and 715 and a surface plasmons 714 in FIG. 14A and FIG. 14B are not used in the description of this exemplary embodiment.

And, when the light C of FIG. 14B is totally reflected off the interface between the birefringent layer 702 and the metal layer 703, and generates an evanescent light 722, the wave number of the evanescent light 722 and the wave number of a surface plasmon at the interface between the metal layer 703 and the low refractive index layer 704 do not coincide, and it does not excite the surface plasmon, and it is reflected by the metal layer 703.

And a loss can reduced by suppressing excitation of a surface plasmon which does not contribute to optical extraction compared with the fifth exemplary embodiment, and use efficiency of light can be improved when using it in combination with a phase modulation means and a reflective means mentioned later.

That is, when the birefringent layers 702 and 706 exist, because light can be taken out only from the surface plasmon propagating in the x direction, an emitted light having a principal component of the polarization component propagating in the zx plane which is the specified direction can be obtained.

Thus, according to the seventh exemplary embodiment, although the light-guide layer 502 of the fifth exemplary embodiment was replaced to the birefringent layer 702, the light 716 having high angular selectivity and polarization selectivity, and having a polarization component of a specified direction is obtained like the fifth exemplary embodiment.

As mentioned above, a polarization component of a specific direction which is in a low state of etendue where the emission direction of the randomly polarized light was fixed to the specific direction can be obtained by using the optical elements of the first to the seventh exemplary embodiments. In the optical elements of the third, the fourth, the sixth and the seventh exemplary embodiments, because excitation of a surface plasmon which does not contribute to optical extraction can be suppressed, more use efficiency of light can be improved.

In the following eighth and ninth exemplary embodiments, optical devices using the optical elements of the first to the seventh exemplary embodiments are described.

### Eighth Exemplary Embodiment

FIG. 15 is a perspective view showing an optical device 800 of an eighth exemplary embodiment of the present invention schematically.

A light source 810 is arranged in a peripheral part of an optical element 801 and emits randomly polarized light to the optical element 801.

The light source 810 may be arranged in a position away from the optical element 801 and it may be arranged so as to be contacted with the optical element 801. The light source 810 may be connected with the optical element 801 optically via a light guiding member like a light pipe.

The optical device 800 includes a reflective means 809, a phase modulation layer 808, the optical element 801 and an angle converting means 807.

The reflective means 809 reflects light which was entered from a phase modulation layer 808 mentioned later in a plane parallel to a metal layer so that an incident angle may not become equal to a reflection angle. As an example, the reflective means 809 may be a diffuse reflector in which particles were embedded, and may be a sawtooth wave shape.

The phase modulation layer 808 modulates a phase state of the incident light. As an example, it is a λ/4 board.

As the optical element 801, any one of the optical elements 101, 201, 301, 401, 501, 601 and 701 of the first to the seventh exemplary embodiments can be used.

The optical device may be employed as lighting.

The angle converting means 807 converts a propagation angle of emitted light. That is, it changes a traveling direction of light. As an example, it is a diffraction grating, a hologram or a photonic crystal.

The phase modulation layer 808 and the reflective means 809 can improve use efficiency of light by converting polarization states and propagation angles of lights B, C, and D, and restoring them to the optical element 801 and reusing.

The angle converting means 807 converts propagation angles of light which has a polarization component of +x direction resulting from a surface plasmon propagated to +x direction, and light which has a polarization component of −x direction resulting from a surface plasmon propagated to −x direction, and can arrange them in the same direction.

In the optical device 800 of the eighth exemplary embodiment, randomly polarized light emitted from a light source can be converted to the specifically polarization state that is in the low state of etendue in which the emission direction thereof is fixed in specific direction. By the angle converting means 807, because the propagation direction of the emitted light can be arranged, the etendue can be reduced more. Because the phase modulation layer 808 and the reflective means 809 are further included, use efficiency of light can be improved.

### Ninth Exemplary Embodiment

FIG. 16 is a perspective view showing an optical device 900 of a ninth exemplary embodiment of the present invention schematically.

The optical device 900 shown in FIG. 16 is added a reflective means 909 to an incident port 920 which is an incident area into which light enters from a light source 910, and an outer wall surface (that is, a side of the optical element 800) except an upper surface which is an emission face for light, and an undersurface on which the reflective means 809 was provided in addition to the configuration of the optical device shown in FIG. 15.

Because the reflective means 909 can suppress light to be emitted from a side face of the optical element 901, use efficiency of light can be improved compared with the optical device 800 shown in FIG. 15.

Further, although the reflective means 909 was provided in all the side faces except the incident port 920, it may be provided only in some face among the side faces. The reflective means 909 may be a diffuse reflector which diffuses and reflects light, and may be a saw-shaped one.

By using the optical device 900 of the ninth exemplary embodiment, the same effect as the eighth exemplary embodiment can be obtained. According to the ninth exemplary embodiment, because the reflective means is provided in an external wall surface, it can suppress light to be leaked from the side face. Therefore, use efficiency of light is improved compared with the eighth exemplary embodiment.

Above, in the eighth and the ninth exemplary embodiments, a light source is not limited to one, and a plurality of light sources may be arranged, and the plurality of light sources may emit lights of the different wavelengths respectively. More particularly, the wavelengths of the plurality of light sources may be different to such an extent that they excite a surface plasmon on a metal surface.

In the following tenth and eleventh exemplary embodiments, display devices using the optical elements of the eighth and the ninth exemplary embodiments will be described.

### Tenth Exemplary Embodiment

In this exemplary embodiment, a projector 1011 which is a display device provided with any one of the optical devices 800 and 900 which were explained in the eighth and the ninth exemplary embodiments will be explained.

FIG. 17 is a layout drawing showing an example of a configuration of a display device of this exemplary embodiment. In FIG. 17, a projector 1011 which is a projection type image display device includes light sources 1012a, 1012b and 1012c, optical elements 1013a, 1013b and 1013c, liquid crystal panels 1014a, 1014b and 1014c, a cross dichroic prism 1015 and a projection optical system 1016.

The light source 1012a and the optical element 1013a, the light source 1012b and the optical element 1013b, and the light source 1012c and the optical element 1013c compose optical device 800 or 900.

It is assumed that each of the light sources 1012a, 1012b and 1012c generates light in which the wavelength is different respectively. Hereinafter, it is assumed that red light is emitted from the light source 1012a, and green light is emitted from the light source 1012b, and blue light is emitted from the light source 1012c.

Each of optical elements 1013a, 1013b and 1013c is equivalent to one deleted a light source of the optical devices 800 and 900 described in the eighth and the ninth exemplary embodiments, and changes each colored light into a predetermined polarization state, and leads it to each of liquid crystal panels 1014a, 1014b, and 1014c.

The liquid crystal panels 1014a, 1014b and 1014c are spatial optical modulating elements which make respective colored lights to carry an image by modulating the respective incident colored lights two-dimensionally corresponding to video signals, and emit the respective colored lights carrying the image. Here, although the liquid crystal panel was employed as the spatial optical modulating element, the spatial optical modulating element may be a digital micro mirror device.

The cross dichroic prism 1015 synthesizes the respective modulated lights emitted from the respective liquid crystal panels 1014a, 1014b and 1014c and emits.

The projection optical system 1016 projects the synthesized light emitted from the cross dichroic prism 1015 on a screen 1017 and displays an image according to the video signal on the screen 1017.

In the projector 1011 of the tenth exemplary embodiment, when a randomly polarized light emitted from a light source is converted into a specifically polarized state, because it is converted to the low state of etendue where the emission direction thereof is fixed in the specific direction, use efficiency of light can be improved.

### Eleventh Exemplary Embodiment

FIG. 18 is a layout drawing showing a different example of a configuration of the display device of the tenth exemplary embodiment. In FIG. 18, a projector 1111 includes light sources 1112a, 1112b and 1112c, an optical element 1113, a liquid crystal panel 1114 and a projection optical system 1116.

The optical element 1113 has the same configuration as the optical elements 1013a, 1013b, or 1013c described in the tenth exemplary embodiment. Accordingly, the light sources 1112a, 1112b and 1111c, and then optical element 1113 will be an optical device having the same configurations as case when light sources in the optical device 800 or 900 explained in the tenth exemplary embodiment are three.

The liquid crystal panel 1114 is an optical modulating element which modulates the incident synthesized light according to the video signal and emits.

The projection optical system 1116 projects the modulated light emitted from the liquid crystal panel 1114 on a screen 1117, and displays an image according to the video signal on the screen 1117.

In the eleventh exemplary embodiment, although the liquid crystal panel was employed as the optical modulating element, the optical modulating element is not limited to the liquid crystal panel, it can be changed appropriately. For example, in the projector shown in FIG. 18, a digital micro mirror device may be used instead of the liquid crystal panel 1114.

In the projector 1111 of the eleventh exemplary embodiment, the same effect as that in the tenth exemplary embodiment can be obtained. Because an optical device can be set to one when compared with the tenth exemplary embodiment, the configuration thereof becomes simpler. Therefore, the projector can be miniaturized additionally.

As a modification of a display device of tenth or eleventh exemplary embodiment, the following configuration may be adopted. For example, the face of a display device is composed so that it may become vertical approximately to a polarized light component of a specified direction such as +x direction. Thereby, because light can be condensed efficiently to a projection optical system without using an optical system such as a mirror or a lens, an optical system can be omitted. The above mentioned modification shows only the applicability of the present invention, and it does not add limitation to the present invention.

In each exemplary embodiment described above, an illustrated configuration is a just example, and the present invention is not limited to the configuration. Examples related to the exemplary embodiments of the present invention are described below. The following example is only one instance, and does not limit the present invention.

### Example 1

The effect by the operation of the first exemplary embodiment was confirmed by a simulation (example 1). This simulation was performed about one instance of the first exemplary embodiment and does not limit the present invention.

Components of an optical element of example 1 are referred to the codes of FIG. 1, FIG. 2A and FIG. 2B. FIG. 19 is a graph showing an example of a result of simulation for confirming the effect of the optical element 101 of the first exemplary embodiment.

A two-dimensional rigorous coupling wave analysis method was used for the simulation of example 1. The rigorous coupling wave analysis method is also called the RCWA method. A horizontal axis of FIG. 19 is an incident angle from the light-guide layer 101 to the low refractive index layer 102, and a vertical axis is a transmittance of light to the cover layer 106.

In the simulation of example 1, the light-guide layer 102 and the cover layer 106 are TiO2 (anatase) with a refractive index of 2.5. The low refractive index layer 103 is Y2O3 with a refractive index of 1.9, and the thickness is 50 nm. The metal layer 104 is Ag, and the thickness is 50 nm. The birefringent layer 105 is YVO4 (no=1.9 and ne=2.2), and the thickness is to 50 nm.

In FIG. 19, because the full width at half maximum of the transmittance of a P-polarized light component in the zx plane is about 23.2 degrees, it can be confirmed that a light having high angular selectivity is obtained compared with the full width at half maximum (about 45 degrees) of the emitted light having the Lambertian distribution like an LED. In comparison with the yz plane and the zx plane in the peak value of the transmittance of the P-polarized light component, because the transmittance in the zx plane is twice larger, it is confirmed that the light whose propagation direction is fixed in a specific direction can be obtained. While the peak value of the transmittance of the P-polarized light component in the zx plane is 55%, because the transmittance of the S-polarized light component in the same incident angle is so small that it can be ignored, it is confirmed that a light having high polarization selectivity is obtained.

Thus, in example 1, it was confirmed that a light having high angular selectivity and polarization selectivity, and having a polarization component of a specific direction by using the birefringent layer 105 was obtained.

### Example 2

The effect by the operation of the second exemplary embodiment was confirmed by a simulation (example 2). This simulation was performed about one instance of the second exemplary embodiment and does not limit the present invention.

Components of an optical element of example 2 are referred to the codes of FIG. 3, FIG. 4A and FIG. 4B. FIG. 20 is a graph showing an example of a result of simulation for confirming the effect of the optical element 201 of the second exemplary embodiment.

The two-dimensional RWCA method was used for a simulation like example 1. A horizontal axis of FIG. 20 is an incident angle from the light-guide layer 202 to the low refractive index layer 203, and a vertical axis is a transmittance of light to the cover layer 206.

In the simulation of example 2, the light-guide layer 202 is CeO2 with a refractive index of 2.2. The low refractive index layers 203 and 205 are Al2O3 with a refractive index of 1.7, and the thickness is 50 nm. The metal layer 204 is Ag, and the thickness is 50 nm. The birefringent layer 105 is YVO4 (ne=2.2 and no=1.9).

In FIG. 20, because the full width at half maximum of the transmittance of a P-polarized light component in the zx plane is about 25.7 degrees, it can be confirmed that high light having angular selectivity is obtained compared with an LED. In comparison with the zx plane and the yz plane in the peak value of the transmittance of the P-polarized light component, because the transmittance in the zx plane is about three times larger, it is confirmed that light whose propagation direction is fixed in a specific direction can be obtained. While the peak value of the transmittance of the P-polarized light component in the zx plane is 62%, because the transmittance of the S-polarized light component in the same incident angle is so small that it can be ignored, it is confirmed that a light having high polarization selectivity is obtained.

Thus, in example 21, it was confirmed that light having high angular selectivity and polarization selectivity, and having a polarization component of a specific direction by using the birefringent layer 206 was obtained.

### Example 3

The effect by the operation of the third exemplary embodiment was confirmed by a simulation (example 3). This simulation was performed about one instance of the third exemplary embodiment and does not limit the present invention.

Components of an optical element of example 3 are referred to the codes of FIG. 5, FIG. 6A and FIG. 6B.

The two-dimensional rigorous coupling wave analysis method was used for the simulation like example 3.

In the simulation of example 3, the light-guide layer 302 and the cover layer 306 are TiO2 (anatase) with a refractive index of 2.5. The birefringent layers 303 and 305 are YVO4 (no=1.9 and ne=2.2), and the thickness is to 50 nm. The metal layer 104 is Ag, and the thickness is 50 nm.

In FIG. 21, because the full width at half maximum of the transmittance of a P-polarized light component in the zx plane is about 23.2 degrees, it can be confirmed that a light having high angular selectivity is obtained compared with an LED. In comparison with the zx plane and the yz plane in the peak value of the transmittance of the P-polarized light component, because the transmittance in the zx plane is five times or more larger, it is confirmed that the light whose propagation direction is fixed in a specific direction can be obtained. While the peak value of the transmittance of the P-polarized light component in the zx plane is 55%, because the transmittance of the S-polarized light component in the same incident angle is so small that it can be ignored, it is confirmed that a light having high polarization selectivity is obtained. When compared with examples 1 and 2, because a clear peak is not seen in the P-polarized light component in the yz plane, it is confirmed that excitation of a surface plasmon which does not contribute to optical extraction can be suppressed.

Thus, in example 3, although the low refractive index layer 103 in example 1 was replaced to the birefringent layer 303, it was confirmed that light having high angular selectivity and polarization selectivity, and having a polarization component of a specific direction like example 1 was obtained.

### Example 4

The effect by the operation of the fourth exemplary embodiment was confirmed by a simulation (example 4). This simulation was performed about one instance of the fourth exemplary embodiment and does not limit the present invention.

Components of an optical element of example 4 are referred to the codes of FIG. 7, FIG. 8A and FIG. 8B. FIG. 22 is a graph showing an example of a result of simulation for confirming the effect of the optical element 401 of the fourth exemplary embodiment.

The two-dimensional RWCA method was used for a simulation like example 1. A horizontal axis of FIG. 22 is an incident angle from the birefringent layer 402 to the low refractive index layer 403, and a vertical axis is a transmittance of light to the birefringent layer 406.

In the simulation of example 4, the birefringent layers 402 and 406 are YVO4 (ne=2.2 and no=1.9). The low refractive index layers 403 and 405 are Al2O3 with a refractive index of 1.7, and the thickness is 50 nm. The metal layer 104 is Ag, and the thickness is 50 nm.

In FIG. 22, because the full width at half maximum of the transmittance of a P-polarized light component in the zx plane is about 25.7 degrees, it can be confirmed that light having high angular selectivity is obtained compared with an LED. In comparison with the zx plane and the yz plane in the peak value of the transmittance of the P-polarized light component, because the transmittance in the zx plane is three times or more large, it is confirmed that the light whose propagation direction is fixed in a specific direction can be obtained. While the peak value of the transmittance of the P-polarized light component in the zx plane is 62%, because the transmittance of the S-polarized light component in the same incident angle is so small that it can be ignored, it is confirmed that light having high polarization selectivity is obtained. Like the third exemplary embodiment, because a clear peak is not seen in the P-polarized light component in the yz plane, it is confirmed that excitation of a surface plasmon which does not contribute to optical extraction can be suppressed.

Thus, in example 4, although light-guide layer 202 in example 2 was replaced to the birefringent layer 402, it was confirmed that light having high angular selectivity and polarization selectivity, and having a polarization component of a specific direction like example 2 was obtained.

### Example 5

The effect by the operation of the fifth exemplary embodiment was confirmed by a simulation (example 5). This simulation was performed about one instance of the fifth exemplary embodiment and does not limit the present invention.

Components of an optical element of example 5 are referred to the codes of FIG. 9, FIG. 10A and FIG. 10B. FIG. 23 is a graph showing an example of a result of simulation for confirming the effect of the optical element 501.

The two-dimensional rigorous coupling wave analysis method was used for the simulation like example 1. A horizontal axis of FIG. 23 is an incident angle from the light-guide layer 502 to the metal layer 503, and a vertical axis is a transmittance of light to the birefringent layer 506.

In the simulation of example 5, the light-guide layer 502 is CeO2 with a refractive index of 2.2. The metal layer 503 is Ag, and the thickness is 50 nm, and the metal layer 505 is Ag, and the thickness is 12.5 nm. The low refractive index layer 504 is Al2O3 with a refractive index of 1.7, and the thickness is 50 nm. The birefringent layer 506 is YVO4 (ne=2.2 and no=1.9).

In FIG. 23, because the full width at half maximum of the transmittance of a P-polarized light component in the zx plane is about 39.7 degrees, it can be confirmed that light having high angular selectivity is obtained compared with an LED. In comparison with the zx plane and the yz plane in the peak value of the transmittance of the P-polarized light component, because the transmittance in the zx plane is about twice larger, it is confirmed that the light whose propagation direction is fixed in a specific direction can be obtained. While the peak value of the transmittance of the P-polarized light component in the zx plane is 60%, because the transmittance of the S-polarized light component in the same incident angle is so small that it can be ignored, it is confirmed that a light having high polarization selectivity is obtained.

Thus, although the optical element 501 of example 5 is different from the optical element 101 of example 1, and composed of a two-layer metal layer, it was confirmed that light having high angular selectivity and polarization selectivity, and having a polarization component of a specific direction like example 1 was obtained.

### Example 6

The effect by the operation of the third exemplary embodiment was confirmed by a simulation (example 6). This simulation was performed about one instance of the sixth exemplary embodiment and does not limit the present invention

Components of an optical element of example 6 are referred to the codes of FIG. 11, FIG. 12A and FIG. 12B. FIG. 24 is a graph showing an example of a result of simulation for confirming the effect of the optical element 601 of the sixth exemplary embodiment.

The two-dimensional RWCA method was used for a simulation like example 1. A horizontal axis of FIG. 24 is an incident angle from the light-guide layer 602 to the metal layer 603, and a vertical axis is a transmittance of light to the cover layer 606.

In the simulation of example 6, the light-guide layer 602 and the cover layer 606 are TiO2 with a refractive index of 2.7. The metal layer 603 is Ag, and the thickness is 25 nm, and the metal layer 605 is Ag, and the thickness is 12.5 nm. The birefringent layers 604 is YVO4 (no=1.9 and ne=2.2), and the thickness is 50 nm.

In FIG. 24, because the full width at half maximum of the transmittance of a P-polarized light component in the zx plane is about 35.6 degrees, it can be confirmed that high light having angular selectivity is obtained compared with an LED. In comparison with the zx plane and the yz plane in the peak value of the transmittance of the P-polarized light component, because the transmittance in the zx plane is about 1.7 times larger, it is confirmed that light whose propagation direction is fixed in a specific direction can be obtained. While the peak value of the transmittance of the P-polarized light component in the zx plane is 59%, because the transmittance of the S-polarized light component in the same incident angle is so small that it can be ignored, it is confirmed that light having high polarization selectivity is obtained.

Thus, although the low refractive index layer 504 and the birefringent layer 506 in example 5 were replaced to the cover layer 606 and the birefringent layer 604 respectively in the optical element 601 of example 6, it was confirmed that light having high angular selectivity and polarization selectivity, and having a polarization component of a specific direction was obtained like example 5.

### Example 7

The effect by the above operation was confirmed by a simulation. FIG. 25 is a graph showing an example of a result of simulation for confirming the effect of the optical element 701 of the seventh exemplary embodiment. This simulation was performed about one instance of the seventh exemplary embodiment and does not limit the present invention.

The two-dimensional RWCA method was used for a simulation like the first exemplary embodiment. A horizontal axis of FIG. 25 is an incident angle from the birefringent layer 702 to the metal layer 703, and a vertical axis is a transmittance of light to the birefringent layer 706.

In the simulation of the seventh exemplary embodiment, the birefringent layers 702 and 706 are YVO4 (ne=2.2 and no=1.9). The metal layer 703 is Ag, and the thickness is 25 nm, and the metal layer 705 is Ag, and the thickness is 12.5 nm. The low refractive index layer 704 is Al2O3 with a refractive index of 1.7, and the thickness is 50 nm.

In FIG. 25, because the full width at half maximum of the transmittance of a P-polarized light component in the zx plane is about 39.7 degrees, it can be confirmed that light having high angular selectivity is obtained compared with an LED. In comparison with the zx plane and the yz plane in the peak value of the transmittance of the P-polarized light component, because the transmittance in the zx plane is twice or more large, it is confirmed that the light whose propagation direction is fixed in a specific direction can be obtained. While the peak value of the transmittance of the P-polarized light component in the zx plane is 60%, because the transmittance of the S-polarized light component in the same incident angle is so small that it can be ignored, it is confirmed that light having high polarization selectivity is obtained.

Thus, although the light-guide layer 502 in the fifth exemplary embodiment was replaced to the birefringent layer 702 in the seventh exemplary embodiment by the simulation of example 7, it was confirmed that light having high angular selectivity and polarization selectivity, and having a polarization component of a specific direction like the fifth exemplary embodiment was obtained.

As mentioned above, it was confirmed from the simulations of example 1 to example 7 that a polarization component of a specific direction which is in a low state of etendue where the emission direction of the randomly polarized light is fixed to the specific direction can be obtained by using the optical elements of the first to the seventh exemplary embodiments.

Although a part or all of the above mentioned exemplary embodiments may be described also like the following supplementary notes, they are not limited to the followings.

(Supplementary note 1) An optical element including: a first dielectric layer; a second dielectric layer; and a first metal layer arranged between the first dielectric layer and the second dielectric layer, wherein the first dielectric layer has different refractive indices in a first direction, and a second direction intersecting with the first direction.

(Supplementary note 2) The optical element according to supplementary note 1, wherein the first dielectric layer includes a birefringent material.

(Supplementary note 3) The optical element according to supplementary note 2, wherein the birefringent material consists of a YVO4 (yttrium vanadate) crystal.

(Supplementary note 4) The optical element according to any one of supplementary notes 1 to 3, wherein the first direction and the second direction are different from a lamination direction for the first dielectric layer, the first metal layer, and the second dielectric layer to have been laminated.

(Supplementary note 5) The optical element according to any one of supplementary notes 1 to 4, wherein the second direction is a direction substantially orthogonal to the first direction.

(Supplementary note 6) The optical element according to any one of supplementary notes 1 to 5 including a third dielectric layer arranged between the first dielectric layer and the first metal layer.

(Supplementary note 7) The optical element according to supplementary note 6, wherein refractive index of the first dielectric layer is larger than a refractive index of the third dielectric layer.

(Supplementary note 8) The optical element according to supplementary notes 6 or 7 including a fourth dielectric layer arranged between the second dielectric layer and the first metal layer.

(Supplementary note 9) The optical element according to supplementary note 8, wherein a refractive index of the second dielectric layer is larger than a refractive index of the fourth dielectric layer.

(Supplementary note 10) The optical element according to supplementary note 8 or 9, wherein a refractive index of the third dielectric layer and a refractive index of the fourth dielectric layer are approximately equal.

(Supplementary note 11) The optical element according to any one of supplementary notes 6 to 10, wherein the second dielectric layer has a refractive index approximately equal to any one of refractive indices which the first dielectric layer has.

(Supplementary note 12) The optical element according to any one of supplementary notes 1 to 5 including a fifth dielectric layer, wherein the fifth dielectric layer is arranged so that the first dielectric layer may be located between the fifth dielectric layer and the first metal layer.

(Supplementary note 13) The optical element according to supplementary note 12, wherein: a refractive index of the fifth dielectric layer is larger than a refractive index of the first dielectric layer.

(Supplementary note 14) The optical element according to supplementary note 12 or 13 including a sixth dielectric layer, wherein: the sixth dielectric layer is arranged so that the second dielectric layer may be located between the sixth dielectric layer and the first metal layer.

(Supplementary note 15) The optical element according to supplementary note 14, wherein: a refractive index of the sixth dielectric layer is larger than a refractive index of the second dielectric layer.

(Supplementary note 16) The optical element according to supplementary notes 14 or 15, wherein a refractive index of the fifth dielectric layer and a refractive index of the sixth dielectric layer are approximately equal.

(Supplementary note 17) The optical element according to any one of supplementary notes 12 to 16, wherein: the second dielectric layer has a refractive index approximately equal to any one of refractive indices which the first dielectric layer has.

(Supplementary note 18) The optical element according to any one of supplementary notes 1 to 5 including a second metal layer, wherein: the second metal layer is arranged so that the first dielectric layer may be located between the second metal layer and the first metal layer.

(Supplementary note 19) The optical element according to supplementary note 18, wherein: a refractive index of the second dielectric layer is larger than a refractive index of the first dielectric layer.

(Supplementary note 20) The optical element according to supplementary note 18 or 19 including a seventh dielectric layer, wherein: the seventh dielectric layer is arranged so that the second metal layer may be located between the seventh dielectric layer and the first dielectric layer.

(Supplementary note 21) The optical element according to supplementary note 20, wherein: a refractive index of the seventh dielectric layer is larger than a refractive index of the first dielectric layer.

(Supplementary note 22) The optical element according to supplementary note 20 or 21, wherein: the second dielectric layer has a refractive index approximately equal to any one of refractive indices which the seventh dielectric layer has.

(Supplementary note 23) The optical element according to any one of supplementary notes 18 to 22, wherein: a refractive index of the first metal layer and a refractive index of the second metal layer are approximately equal.

(Supplementary note 24) The optical element according to any one of supplementary notes 1 to 5 including: a third metal layer arranged between the first metal layer and the second dielectric layer; and an eighth dielectric layer arranged between the first metal layer and the third metal layer.

(Supplementary note 25) The optical element according to supplementary note 24, wherein: a refractive index of the first dielectric layer is larger than a refractive index of the eighth dielectric layer.

(Supplementary note 26) The optical element according to supplementary notes 24 or 25, wherein: a refractive index of the second dielectric layer is larger than a refractive index of the eighth dielectric layer.

(Supplementary note 27) The optical element according to any one of supplementary notes 24 to 26, wherein: the second dielectric layer has a refractive index approximately equal to any one of refractive indices which the first dielectric layer has.

(Supplementary note 28) The optical element according to any one of supplementary notes 24 to 27, wherein: a refractive index of the first metal layer and a refractive index of the third metal layer are approximately equal.

(Supplementary note 29) The optical element according to any one of supplementary notes 18 to 23, wherein: a thickness of the second metal layer is 50 nm or less.

(Supplementary note 30) The optical element according to any one of supplementary notes 18 to 23 and 29, wherein: a thickness of the second metal layer is 25 nm or less.

(Supplementary note 31) The optical element according to any one of supplementary notes 18 to 23, 29 and 30, wherein: the second metal layer includes any one of Ag, Al and Au.

(Supplementary note 32) The optical element according to any one of supplementary notes 24 to 28, wherein a thickness of the third metal layer is 50 nm or less.

(Supplementary note 33) The optical element according to any one of supplementary notes 24 to 28 and 32, wherein: the thickness of the third metal layer is 25 nm or less.

(Supplementary note 34) The optical element according to any one of supplementary notes 24 to 28, 32 and 33, wherein: the third metal layer includes any one of Ag, Al and Au.

(Supplementary note 35) The optical element according to any one of supplementary notes 1 to 34, wherein: a thickness of the first metal layer is 200 nm or less.

(Supplementary note 36) The optical element according to any one of supplementary notes 1 to 35, wherein: the thickness of the first metal layer is 30 nm to 100 nm.

(Supplementary note 37) The optical element according to any one of supplementary notes 1 to 36, wherein: the first metal layer includes any one of Ag, Al and Au.

(Supplementary note 38) The optical element according to any one of supplementary notes 1 to 37, wherein: the second dielectric layer has different refractive indices in the first direction and the second direction intersecting with the first direction.

(Supplementary note 39) The optical element according to any one of supplementary notes 1 to 37, wherein: the second dielectric layer includes any one of TiO2 and Y2O3.

(Supplementary note 40) The optical element according to any one of supplementary notes 6 to 11, 24 to 28, and 32 to 34 including an angle converting means for changing a traveling direction of light, wherein: the angle converting means is arranged so that the first dielectric layer may be located between the angle converting means and the first metal layer.

(Supplementary note 41) The optical element according to any one of supplementary notes 12 to 17 including an angle converting means for changing a traveling direction of light, wherein: the angle converting means is arranged so that the fifth dielectric layer may be located between the angle converting means and the first dielectric layer.

(Supplementary note 42) The optical element according to any one of supplementary notes 20 to 22 including an angle converting means for changing a traveling direction of light, wherein: the seventh dielectric layer is arranged between the angle converting means and the second metal layer.

(Supplementary note 43) The optical element according to any one of supplementary notes 40 to 42, wherein the angle converting means is a diffraction grating.

(Supplementary note 44) The optical element according to any one of supplementary notes 40 to 42, wherein: the angle converting means is a hologram.

(Supplementary note 45) The optical element according to any one of supplementary notes 6 to 11, 18 to 34, 40 and 42 including a phase modulation means for modulating a phase of light, wherein: the phase modulation means is arranged so that the second dielectric layer may be located between the phase modulation means and the first metal layer.

(Supplementary note 46) The optical element according to any one of supplementary notes 14 to 16 including a phase modulation means for modulating a phase of light, wherein: the phase modulation means is arranged so that sixth dielectric layer may be located between the phase modulation means and the second dielectric layer.

(Supplementary note 47) The optical element according to supplementary note 45 or 46, wherein: the phase modulation means is a quarter-wave plate.

(Supplementary note 48) The optical element according to any one of supplementary notes 6 to 11, 18 to 34, 40, 42 and 45 including a reflective means for reflecting light, wherein: the reflective means is arranged so that the second dielectric layer may be located between the reflective means and the first metal layer.

(Supplementary note 49) The optical element according to any one of supplementary notes 14 to 16 and 46 including a reflective means for reflecting light, wherein: the reflective means is arranged so that the sixth dielectric layer may be located between the reflective means and the second dielectric layer.

(Supplementary note 50) The optical element according to supplementary notes 48 or 49, wherein the reflective means is a diffuse reflection layer which diffuses and reflects light.

(Supplementary note 51) The optical element according to supplementary notes 48 or 49, wherein: the reflective means has a reflective surface of a sawtooth wave shape.

(Supplementary note 52) An optical device including: an optical element according to any one of supplementary notes 1 to 51; and a light source, wherein: the light source is arranged so that light emitted from the light source may enter the optical element.

(Supplementary note 53) The optical device according to supplementary note 52, wherein: the light source is arranged so that light emitted from the light source may enter a top layer or a bottom layer of the optical element.

(Supplementary note 54) The optical device according to supplementary note 52, wherein: the light source is arranged so that light emitted from the light source may enter a side face of a top layer or a side face of a bottom layer of the optical element.

(Supplementary note 55) The optical device according to any one of supplementary notes 52 to 54, wherein: the light source is arranged so that a traveling direction of the light which entered the first dielectric layer may be different from both the first direction and the second direction.

(Supplementary note 56) A display device including: an optical device according to any one of supplementary notes 52 to 55; a spatial optical modulating element which modulates and emits light emitted from the optical device; and a projection optical system which projects light emitted from the spatial optical modulating element.

(Supplementary note 57) The display device according to supplementary note 56, wherein: the spatial optical modulating element is a liquid crystal panel.

(Supplementary note 58) The display device according to supplementary note 56, wherein: the spatial optical modulating element is a digital micro mirror device.

As mentioned above, although the present invention has been described with reference to the exemplary embodiments and the examples, the present invention is not limited to the above-mentioned exemplary embodiments and examples. The structure and details of the present invention may be changed in various manners understood by those skilled in the art within the scope of the present invention.

This application is based upon and claims the benefit of priority from Japanese patent application No. 2012-50647, filed on Mar. 7, 2012, the disclosure of which is incorporated herein in its entirety by reference.

### INDUSTRIAL APPLICABILITY

The present invention relates to an optical element, an optical device and a display device which convert a randomly polarized light to a specifically polarization state. The optical element and the optical device of the present invention can be used for a light source unit of a liquid crystal projector. The display device of the present invention can compose a liquid crystal projector.

### DESCRIPTION OF THE REFERENCE NUMERALS

2 LED
3 light guide plate
6 reflector
10 light guide
11 polarization separation film
12 upper surface cover
13 polarization direction change member
14 micro prism
101, 201, 301, 401, 501, 601, 701, 801, 1013a, 1013b, 1013c, 1113 optical element
102, 202, 302, 502, 602 light-guide layer
103, 203, 206, 403, 405, 504, 704 low refractive index layer
104, 204, 304, 404, 503, 505, 603, 605, 703, 705 metal layer
105, 205, 303, 305, 402, 406, 506, 604, 702, 706 birefringent layer
106, 306, 606 cover layer
112, 122, 212, 222, 312, 322, 412, 422, 512, 522, 612, 622, 712, 722 evanescent light
115, 215, 315, 415, 515, 615, 715 evanescent light
113, 123, 213, 223, 313, 413, 513, 523, 613, 713, 723 surface plasmon
114, 124, 214, 224, 314, 414, 514, 524, 614, 714 surface plasmon
116, 216, 316, 416, 516, 616, 716 light
800, 900 optical device
807 angle converting means
808 phase modulation layer
809, 909 reflective means
810, 910 light source
920 incident port.
1011, 1111 projector
1012a, 1012b, 1012c, 1112a, 1112b, 1112c light source
1014a, 1014b, 1014c, 1114 liquid crystal panel
1015 cross dichroic prism
1016, 1116 projection optical system
1017, 1117 screen

1. An optical element comprising: a first dielectric layer;
a second dielectric layer; and
a first metal layer arranged between the first dielectric layer and the second dielectric layer, wherein: the first dielectric layer has different refractive indices in a first direction and a second direction intersecting with the first direction.

2. The optical element according to claim 1, wherein: the first dielectric layer includes a birefringent material.

3. The optical element according to claim 1, wherein the first direction and the second direction are different from a lamination direction for the first dielectric layer, the first metal layer, and the second dielectric layer to have been laminated.

4. The optical element according to claim 1 comprising a third dielectric layer arranged between the first dielectric layer and the first metal layer.

5. The optical element according to claim 1 including a fifth dielectric layer, wherein: the fifth dielectric layer is arranged so that the first dielectric layer may be located between the fifth dielectric layer and the first metal layer.

6. The optical element according to claim 1 comprising a second metal layer, wherein the second metal layer is arranged so that the first dielectric layer may be located between the second metal layer and the first metal layer.

7. The optical element according to claim 1 comprising: a third metal layer arranged between the first metal layer and the second dielectric layer; and
an eighth dielectric layer arranged between the first metal layer and the third metal layer.

8. The optical element according to claim 4, wherein: the second dielectric layer has a refractive index approximately equal to any one of refractive indices which the first dielectric layer has.

9. An optical device comprising: an optical element according to claim 1; and
a light source, wherein: the light source is arranged so that light emitted from the light source may enter the optical element.

10. A display device comprising: an optical device according to claim 9;
a spatial optical modulating element which modulates and emits light emitted from the optical device; and
a projection optical system which projects light emitted from the spatial optical modulating element.
